(19) United States
(12) Patent Application Publication
(10) Pub. No.: US 2011/0090211 A1
(43) Pub. Date: Apr. 21, 2011

(54) CIRCUIT FOR DRIVING PLASMA DISPLAY PANEL AND PLASMA DISPLAY DEVICE

(75) Inventors: Yasuhiro Arai, Osaka (JP); Toshikazu Wakabayashi, Osaka (JP); Satoshi Kominami, Osaka (JP); Masumi Izuchi, Osaka (JP); Junko Matsushita, Osaka (JP); Hiroyasu Makino, Osaka (JP); Hideki Nakata, Osaka (JP)

(73) Assignee: PANASONIC CORPORATION, Osaka (JP)

(21) Appl. No.: 12/999,842

(22) PCT Filed: Jun. 23, 2009
(86) PCT No.: PCT/JP2009/002856

§ 371 Date: Dec. 17, 2010

(30) Foreign Application Priority Data
Jun. 26, 2008 (JP) 2008-166804
May 13, 2009 (JP) 2009-116664

(51) Int. Cl. G09G 5/00; G09G 3/28

(52) U.S. Cl. 345/211; 345/60

(57) ABSTRACT

A simple, low cost drive circuit secures a sufficient number of subfields in a high resolution panel. The plasma display panel drive circuit groups plural sustain electrodes into first and second sustain electrode groups, and applies sustain pulses in the sustain period. The first and second sustain pulse generating circuits generate and apply sustain pulses to first and second electrode paths. First and second specific voltage application circuits apply a first specific voltage to the first and second electrode paths. The voltage selection circuit selects one of a plurality of voltages including at least a second specific voltage and a third specific voltage, and generates a selected voltage. The first and second sustain pulse generating circuits generate the sustain pulses based on the second specific voltage when the selected voltage is the second specific voltage, and when the selected voltage is the third specific voltage, apply the third specific voltage to the first and second electrode paths.

### BACKGROUND OF THE INVENTION

1. Technical Field

The present invention relates to a plasma display panel drive circuit and to a plasma display device, and relates more particularly to a circuit for driving plasma display panel and to a plasma display device that uses this drive circuit.

2. Related Art

Surface discharge AC display panels, of which a plasma display panel (simply “panel” below) is typical, have numerous discharge cells disposed between opposing front and back plates.

A plurality of parallel, alternating display electrode pairs each including a scan electrode and a sustain electrode are formed on the front plate, and a plurality of parallel data electrodes (address electrodes) are formed on the back plate. The front and back plates are disposed facing each other and sealed with the display electrode pairs and address electrodes perpendicular to each other, and the discharge space between the front and back plates is charged with a discharge gas. The discharge cells are formed in this space between the display electrode pairs and the address electrodes.

The panel is driven using a subfield drive method whereby one field is divided into plural subfields and gradations are displayed by controlling the combination of subfields.

Each subfield has an initialization period, an address period, and a sustain period. A priming discharge is produced in the initialization period in order to form the wall charge required in the following address operation. In the address period, an address discharge is selectively produced in the discharge cells according to the image to be displayed to produce a wall charge. In the sustain period, a sustain pulse voltage is alternately applied to the display electrode pairs to produce a sustain discharge, thereby causing the phosphor layers of the corresponding discharge cells to emit and display an image.

This separated address and sustain method in which the address period and sustain period are temporally separated so that they do not overlap by aligning the phase of the sustain period in all discharge cells is a commonly used subfield drive method. Because there is no time in this separated address and sustain method when discharge cells producing an address discharge and discharge cells producing a sustain discharge coexist, the panel can be driven under conditions optimal for an address discharge in the address period and conditions optimal for a sustain discharge in the sustain period. As a result, discharge control is relatively simple, and a relatively large drive margin can be set for the panel.

Conversely, if the time required for the address period becomes longer as panel resolution increases as a result of setting the sustain period in a period not including the address period with the separated address and sustain method, it may not be possible to secure enough subfields to improve image display quality.

To solve this problem, Japanese Unexamined Patent Appl. Pub. JP-A-2005-157338 teaches technology for dividing the display electrode pairs into plural groups, and driving the panel by shifting the subfield start time in each group so that the address periods of any two or more of the plural groups do not overlap temporally.

The drive circuit taught in JP-A-2005-157338, however, requires the same number of scan electrode drive circuits and sustain electrode drive circuits as the number of groups of display electrode pairs, increasing the circuit size and the number of circuit parts that are used. As a result, the cost of the drive circuit increases.

### SUMMARY

A simple, low cost plasma display panel drive circuit and a plasma display device according to the present invention can assure a sufficient number of subfields in a high resolution panel.

A first aspect of the invention is a drive circuit that drives a plasma display panel having a plurality of display electrode pairs including a scan electrode and a sustain electrode, and a plurality of data electrodes, and renders discharge cells at the intersections of the display electrode pairs and data electrodes, the drive circuit including: a plurality of sustain pulse generating circuits that divide the plural display electrode pairs into a plurality of display electrode pair groups, each sustain pulse generating circuit corresponding to a display electrode pair group, and apply sustain pulses to the sustain electrodes of the display electrode pair groups; a constant voltage generating circuit disposed for each of the plural display electrode pair groups to apply a constant voltage to the sustain electrodes of the display electrode pair groups; and a voltage selection circuit that selects and supplies one of a plurality of voltages to each of the plural sustain pulse generating circuits.

Another aspect of the invention is a plasma display device including the plasma display panel drive circuit described above and the plasma display panel.

### EFFECT OF THE INVENTION

A plasma display panel drive circuit and a plasma display device according to the invention have one voltage selection circuit that generates one selected voltage, and a plurality of sustain pulse generating circuits can apply sustain pulses based on this one selected voltage or a specific voltage to a plurality of sustain electrode groups in different sustain periods. As a result, a sufficient number of subfields and sustain pulses can be assured in a high resolution panel, and the resolution and brightness of the plasma display panel can be improved. In addition, because the part count can be reduced and the circuit design simplified, the drive circuit can be rendered at a low cost.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a plasma display panel for a plasma display device according to a first embodiment of the invention.

FIG. 2 shows the electrode arrangement of the plasma display panel of the same plasma display device.

FIG. 3 is a timing chart showing the subfield configuration of the plasma display device.

FIG. 4 is a waveform diagram showing the drive voltage signals applied to the electrodes of the plasma display panel of the plasma display device.

FIG. 5 is a block diagram of the plasma display device.

FIG. 6 is a circuit diagram of the scan electrode drive circuit of a plasma display panel according to the first embodiment of the invention.

FIG. 7 is a circuit diagram of the sustain electrode drive circuit of the plasma display panel drive circuit.

FIG. 8 is a waveform diagram of the operation of the sustain electrode drive circuit of the plasma display panel drive circuit.

FIG. 9 shows the electrode arrangement of a plasma display panel in a plasma display device according to a second embodiment of the invention.

FIG. 10 is a timing chart showing the subfield configuration of the plasma display device.

FIG. 11 is a circuit diagram of the operation of the sustain electrode drive circuit of the plasma display panel drive circuit according to the second embodiment of the invention.

FIG. 12 is a circuit diagram of the sustain electrode drive circuit in the plasma display panel drive circuit according to a third embodiment of the invention.

FIG. 13 is a waveform diagram of the operation of the sustain electrode drive circuit of the plasma display panel drive circuit.

FIG. 14 is a circuit diagram of the plasma display panel drive circuit according to a fourth embodiment of the invention.

FIG. 15 is a waveform diagram describing the operation of the plasma display panel drive circuit.

### DESCRIPTION OF EMBODIMENTS

Preferred embodiments of the present invention are described below with reference to the accompanying figures wherein elements expressing the same configuration, operation, and effect are identified by the same reference numeral.

### Embodiment 1

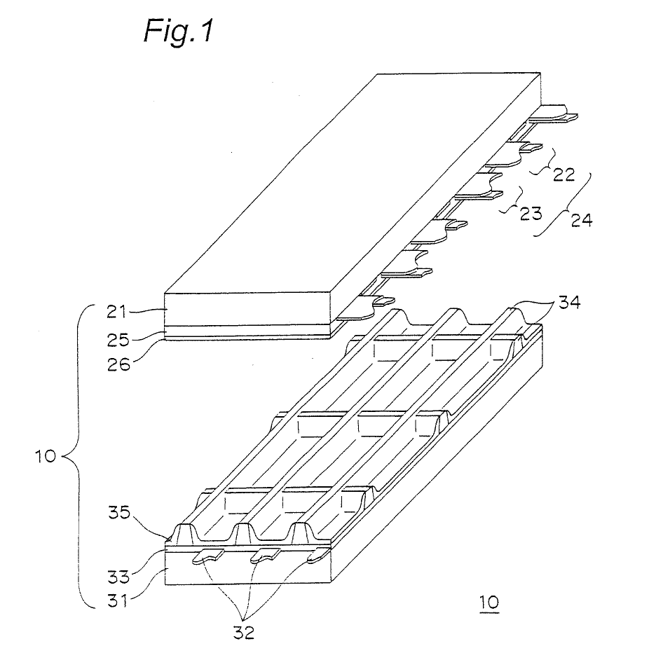

FIG. 1 is an exploded oblique view of a plasma display panel 10 (“panel” below) used in a plasma display device. A plurality of display electrode pairs 24 each composed of a scan electrode 22 and sustain electrode 23 are formed on a glass front plate 21. A dielectric layer 25 is formed covering the display electrode pairs 24, and a protective layer 26 is formed over the dielectric layer 25.

A plurality of data electrodes 32 are formed on a back plate 31, a dielectric layer 33 is formed covering the data electrodes 32, and barrier ribs 34 are formed thereon in a grid-like pattern of wells. A phosphor layer 35 that emits red (R), green (G), and blue (B) is disposed on the sides of the barrier ribs 34 and the top of the dielectric layer 33.

The front plate 21 and back plate 31 are then placed together so that the display electrode pairs 24 and data electrodes 32 intersect with small discharge spaces rendered therebetween, and the perimeter is then sealed with glass frit or other sealing material. A discharge gas of neon, argon, xenon or other rare gas, or a mixture of rare gases, is then injected to the internal discharge space. The discharge space is segmented into a plurality of cells by the barrier ribs 34, and the discharge cells are formed in the parts where the display electrode pairs 24 and data electrodes 32 intersect. An image is displayed by causing these discharge cells to discharge and emit.

It should be noted that the structure of the panel 10 is not limited to the foregoing. For example, the barrier ribs may be rendered in a striped pattern.

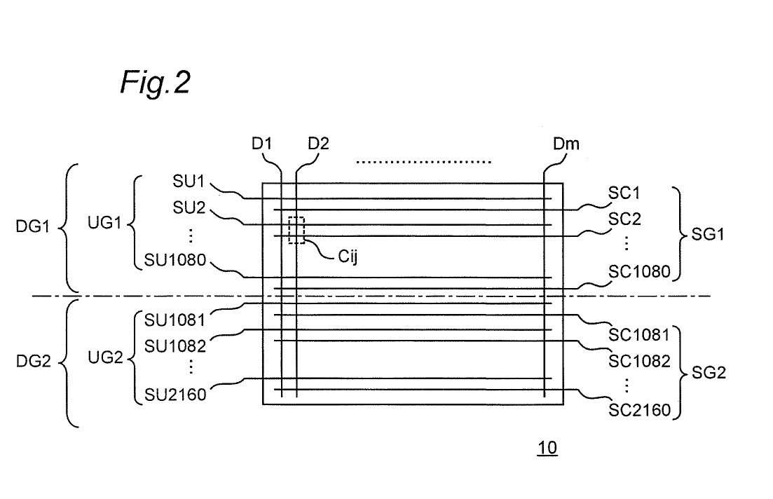

FIG. 2 shows the electrode arrangement of the plasma display device panel 10. As shown in the figure, n scan electrodes SC1, SC2 . . . SCn (scan electrodes 22 in FIG. 1) and n sustain electrodes SU1, SU2 . . . SUn (sustain electrodes 23 in FIG. 1) that are long in the row direction, and m data electrodes D1, D2 . . . Dm (data electrodes 32 in FIG. 1) that are long in the column direction, are formed on the panel 10. A discharge cell Cij (i=1−n; j=1−m) is formed where each display electrode pair n including a scan electrode SCi (i=1, 2, . . . n) and sustain electrode SUi (i=1 . . . n) pair intersects one data electrode Dj (j=1, 2, . . . m). There are m×n discharge cells Cij formed in the discharge space. The number of display electrode pairs is not specifically limited, and in the embodiment described below n=2160.

The 2160 display electrode pairs including scan electrodes SC1-SC2160 and sustain electrodes SU1-SU2160 are divided into plural display electrode pair groups DG1, DG2, . . . DGN. While the method of determining the number N of display electrode pair groups is further described below, the panel in this embodiment of the invention is divided in two parts top and bottom to render two display electrode pair groups DG1 and DG2.

As shown in FIG. 2, the display electrode pairs on the top half of the panel are display electrode pair group DG1, and the display electrode pairs on the bottom half of the panel are display electrode pair group DG2.

The 1080 scan electrodes SC1-SC1080 are scan electrode group SG1, and the 1080 sustain electrodes SU1-SU1080 are sustain electrode group UG1. In addition, the 1080 scan electrodes SC1081-SC2160 are scan electrode group SG2, and the 1080 sustain electrodes SU1081-SU2160 are sustain electrode group UG2. Scan electrode group SG1 and sustain electrode group UG1 thus belong to display electrode pair group DG1, and scan electrode group SG2 and sustain electrode group UG2 belong to display electrode pair group DG2.

The drive configuration for driving the panel 10 is described next. In this example the timing of the scan pulse and the address pulse is set, except during the initialization period, so that the address operation runs continuously. As a result, the greatest possible number of subfields can be set in one field period. This is described below in detail with reference to specific examples.

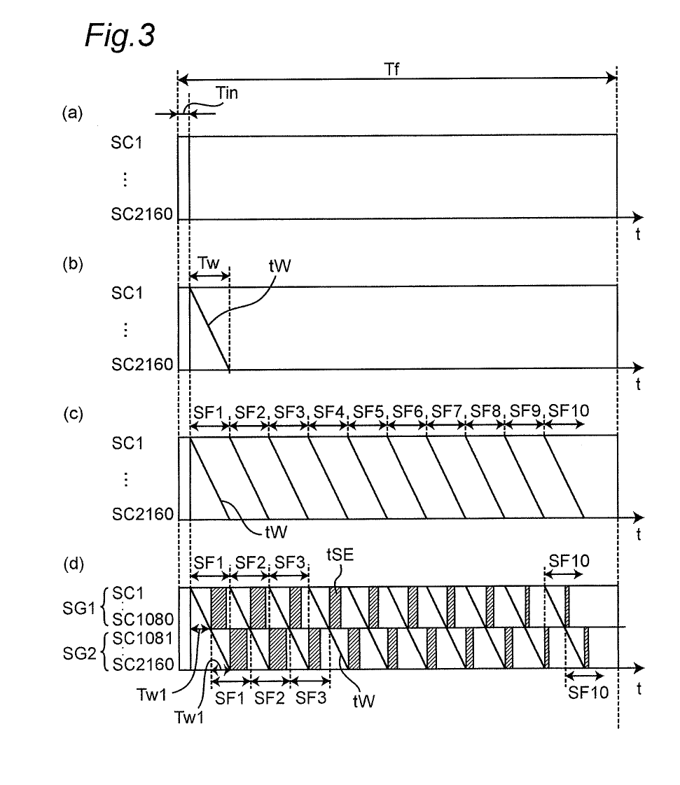

FIG. 3 is a timing chart showing the subfield configuration of the plasma display device. The y-axes in FIG. 3A, FIG. 3B, FIG. 3C, and FIG. 3D denote scan electrodes SC1-SC2160, and the x-axis denotes time t. The timing tW denoting the timing of the address (write) operation is indicated by the solid bold lines, and the sustain/erase period timing tSE denoting the timing of the sustain period and the erase period described below is indicated by the shading. Note that one field period Tf is 16.7 ms in the following example.

As shown in FIG. 3A, an initialization period Tin for producing an initialization discharge simultaneously in all discharge cells is provided at the beginning of one field period Tf. In this example the initialization period Tin is 500 μs.

As shown in FIG. 3B, the total write time Tw denoting the time required to sequentially apply a scan pulse to all scan electrodes SC1-SC2160 (that is, the time required to address all scan electrodes SC1-SC2160 once) is estimated. So that the address operation can execute continuously, the scan pulse is preferably as short as possible and is applied continuously as much as possible. In this example the time required to write one scan electrode is 0.7 μs. Because there are 2160 scan electrodes, the total write time Tw is 0.7×2160=1512 μs.

The subfield count is estimated next. The erase period is ignored at first. If the initialization period Tin is subtracted from one field period Tf and divided by the total write time Tw, (16.7−0.5)/1.5=10.8 ms is obtained. As a result, as shown in FIG. 3C, a maximum of 10 subfields SF1, SF2, . . . SF10 can be secured.

Next, based on the required number of scan pulses, the number of display electrode pair groups N representing the number of display electrode pair groups DG1, DG2, . . . , DGN is determined. In this example the number of sustain pulses applied to the scan electrodes SC1-SC2160 in subfields SF1-SF10 is 60, 44, 30, 18, 11, 6, 3, 2, 1, and 1, respectively. The sustain period Ts1, Ts2, . . . , Ts10 denoting the time required to apply the sustain pulses is the product of the number of sustain pulses applied in subfields SF1 to SF10 times the sustain pulse period. If the sustain pulse period is 10 μs, the maximum sustain period Ts1 representing the maximum sustain period is 0.10×60=600 μs

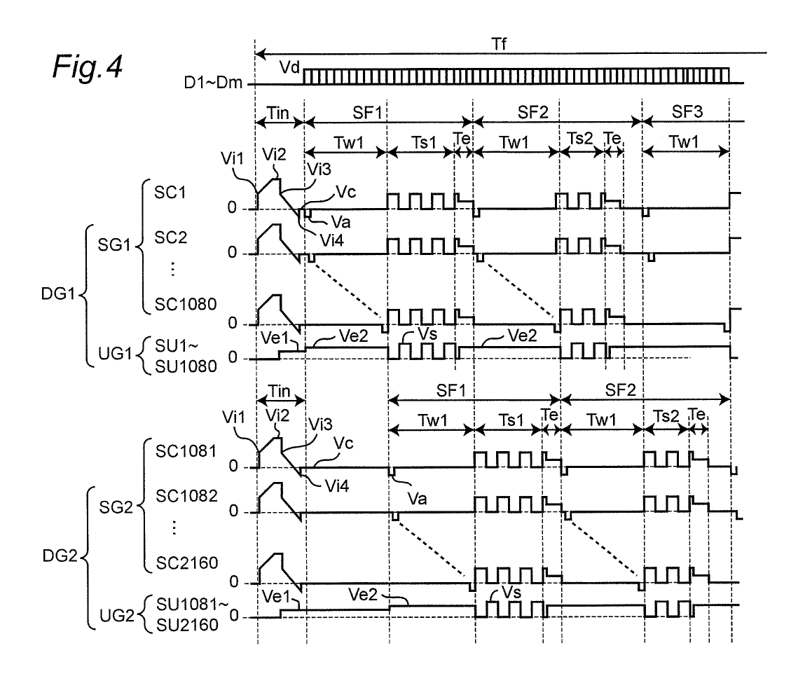

In FIG. 3D and FIG. 4 described below, the address period Tw1 represents the period in the total write time Tw required to address each display electrode pair group DG1-DGN, and is obtained from equation (1).

Tw1=Tw/N (1)

Sustain periods Ts1-Ts10 are provided in subfields SF1-SF10 after address period Tw1. The sustain period of subfield SFq (q=1-10) in display electrode pair group DGp (p=1−N) of display electrode pair groups DG1-DGN is set temporally parallel to the address period Tw1 of subfield SFq in each display electrode pair group DG (p+1)-DGN (where p=1, 2, . . . , N−1). In addition, the sustain period of subfield SFq of display electrode pair group DGp is set temporally parallel to the address period Tw1 of subfield SF(q+1) (where q=1-9) of each display electrode pair group DG1-DG (p−1) (where p=2, 3, . . . N).

The display electrode pair group count N is obtained as the lowest integer satisfying equation (2) below using the total write time Tw and the maximum sustain period Ts1.

N≧Tw/(Tw−Ts1) (2)

The derivation of equation (2) is described next. The original form of equation (2) is equation (3).

Ts1≦Tw×(N−1)/N (3)

Equation (3) shows that the period remaining after subtracting the group-unit address time Tw/N from the total write time Tw must not exceed the maximum sustain period Ts1. In other words, the display electrode pair group count N must be determined so that the period (Tw×(N−1)/N) on the right side of equation (3) is longer than the maximum sustain period Ts1. For example, if a small N that will not satisfy equation (3) is selected, the sustain period of subfield SFq in display electrode pair group DG (N−1) will not have ended when addressing subfield SFq in display electrode pair group DGN is completed. As a result, subfield SF(q+1) in display electrode pair group DG1 cannot be addressed immediately. As a result, writing continuously to the next subfield is not possible, and the drive time cannot be shortened. A natural number N that satisfies equation (3) must therefore be selected. Equation (2) is expressed as the result of the following derivation of equation (3).

As described above, because Tw=1512 μs and Ts1=600 μs,

1512/(1512−600)=1.66 (4)

is obtained from equation (2), and the display electrode pair group count N is 2.

Based on these considerations, the display electrode pairs are divided into two display electrode pair groups DG1, DG2 as shown in FIG. 2. In this configuration, because N=2, Tw=1512 μs, and Ts1=600 μs,

Tw×(N−1)/N=756≧600 (5)

and the condition of equation (3) is satisfied.

The drive configuration for driving the panel 10 and the display electrode pair group count N can be determined as described above. Note that the calculations described above ignore the erase period, but the address operation is preferably not executed during the erase period of any display electrode pair group. This is because the erase period is not only for erasing the wall voltage, but also for adjusting the wall voltage of the data electrodes in preparation for the address operation in the next address period Tw1, and the data electrode voltage is preferably fixed.

The drive voltage signal and operation are described in detail next.

FIG. 4 is a waveform diagram of the drive voltage signals applied to the electrodes of the panel 10 of the plasma display device. FIG. 4 shows, in order from the top, the drive voltage waveform of data electrodes D1-Dm; the drive voltage waveform of the scan electrode group SG1 and sustain electrode group UG1 in display electrode pair group DG1; and the drive voltage waveform of the scan electrode group SG2 and sustain electrode group UG2 in display electrode pair group DG2.

An initialization period Tin for producing an initialization discharge in each discharge cell Cij is provided at the beginning of one field period Tf. After the initialization period Tin in the one field period Tf, subfields SF1-SF10 are provided in display electrode pair groups DG1, DG2 as shown in FIG. 3D. Subfield SFq includes, in order, address period Tw1, sustain period Tsq, and erase period Te (q=1-10).

Erase period Te is a period provided after each sustain period Ts1-Ts10 to produce an erase discharge in the discharge cells that discharged in the sustain period. As described above in FIG. 3D, subfields SF1-SF10 in display electrode pair group DG2 are delayed overall by address period Tw1 from the subfields SF1-SF10 in display electrode pair group DG1. As a result, the sustain period Tsq and erase period Te of the display electrode pair group DG1 are temporally parallel to the address period Tw1 of subfield SFq in display electrode pair group DG2 (q=1-10).

The initialization period Tin is described next.

In the initialization period, Tin voltage 0 (V) is applied to data electrodes D1-Dm and sustain electrodes SU1-SU2160. A voltage with a slope that rises gradually from a positive voltage Vi1, which is lower than the positive discharge start voltage applied to sustain electrodes SU1-SU2160, to a positive voltage Vi2 that is greater than the discharge start voltage is applied to scan electrodes SC1-SC2160. While this slope waveform voltage rises, a weak initialization discharge is produced between the scan electrodes SC1-SC2160 and the sustain electrodes SU1-SU2160 and data electrodes D1-Dm. A negative wall voltage then accumulates on the scan electrodes SC1-SC2160, and a positive wall voltage accumulates on the data electrodes D1-Dm and sustain electrodes SU1-SU2160. The wall voltage on the electrodes represents the voltage produced by the wall charge stored in the dielectric layer covering the electrodes, the protective layer, and the phosphor layer. Note that voltage Vd may be applied to the data electrodes D1-Dm during this time.

Voltage 0 (V) is then applied to the data electrodes D1-Dm; a positive specific voltage Ve1 is applied to sustain electrodes SU1-SU2160; and a sloped waveform voltage that decreases gradually from a positive voltage Vi3 that is lower than the discharge start voltage applied to the sustain electrodes SU1-SU2160 to a negative voltage Vi4 that goes below the negative discharge start voltage is applied to the scan electrodes SC1-SC2160. A weak initialization discharge is produced during this time between the scan electrodes SC1-SC2160, the sustain electrodes SU1-SU2160, and the data electrodes D1-Dm. The negative wall voltage on the scan electrodes SC1-SC2160 and the positive wall voltage on the sustain electrodes SU1-SU2160 weaken, and the positive wall voltage on the data electrodes D1-Dm is adjusted to a value suitable for the address operation. Voltage Vc is then applied to the scan electrodes SC1-SC2160. As a result, the initialization operation producing an initialization discharge in all discharge cells ends.

The address period Tw1 of subfield SF1 in display electrode pair group DG1 is described next.

A positive specific voltage Ve2 that is higher than the specific voltage Ve1 is applied to sustain electrode group UG1. A scan pulse with a negative voltage Va is applied to scan electrode SC1, and an address pulse with a positive voltage Vd is applied to the data electrodes Dj (j=1−m) of the discharge cells that are to emit. The voltage difference at the intersection of data electrode Dj and scan electrode SC1 therefore goes to the sum of the external applied voltage (Vd−Va) plus the difference between the wall voltage on the data electrode Dj and the wall voltage on the scan electrode SC1, and exceeds the discharge start voltage. Discharge then starts between the data electrode Dj and scan electrode SC1, progresses to a discharge between the sustain electrode SU1 and scan electrode SC1, and an address discharge is produced. As a result, a positive wall voltage accumulates on the scan electrode SC1, a negative wall voltage accumulates on the sustain electrode SU1, and a negative wall voltage accumulates on the data electrode Dj. The address operation thus produces an address discharge in all discharge cells that are to emit on the first line, and stores a wall voltage on the electrodes. Because the voltage at the intersection of the scan electrode SC1 and the data electrodes D1 to Dm to which the address pulse was not applied does not exceed the discharge start voltage, an address discharge is not produced.

Next, a scan pulse is applied to the scan electrode SC2 on the second line, and an address pulse is applied to the data electrodes Dj of the discharge cells that are to emit. As a result, an address discharge is produced in the discharge cells of the second line to which a scan pulse and address pulse are simultaneously applied, and the discharge cells are addressed.

This address operation repeats to the discharge cells on line 1080,thereby selectively producing an address discharge and storing a wall charge on the discharge cells that are to emit.

In the address period Tw1 of subfield SF1 in display electrode pair group DG1, voltage Vc is applied to scan electrode group SG2 and specific voltage Ve1 is applied to sustain electrode group UG2. This address period Tw1 is a rest period in which the display electrode pair group DG2 is not made to discharge. The voltage applied to the electrodes in display electrode pair group DG2 is not limited to this voltage, however, and a different voltage may be applied insofar as it does not cause the cells to discharge.

The address period Tw1 of subfield SF1 in display electrode pair group DG2 is described next.

A positive specific voltage Ve2 is applied to sustain electrode group UG2. A scan pulse is applied to scan electrode SC1081, and an address pulse is applied to the data electrodes Dj of the discharge cells that are to emit. As a result, an address discharge is produced between data electrodes Dj and scan electrode SC1081, and between sustain electrode SU1081 and scan electrode SC1081. A scan pulse is then applied to scan electrode SC1082, and an address pulse is applied to the data electrodes Dj of the discharge cells that are to emit. As a result, an address discharge is produced in the discharge cells of line 1082 to which the scan pulse and address pulse were simultaneously applied. This address operation repeats to the discharge cells of line 2160, selectively producing an address discharge and storing a wall charge in the discharge cells that are to emit.

The address period Tw1 of subfield SF1 in display electrode pair group DG2 corresponds to the sustain period Ts1 of subfield SF1 in display electrode pair group DG1. More specifically, 60 sustain pulses are applied to scan electrode group SG1, and 60 sustain pulses are applied to sustain electrode group UG1 one at a time alternately to produce an address discharge and cause the discharge cells to emit.

More specifically, a positive sustain pulse voltage Vs is applied to scan electrode group SG1, and voltage 0 (V) is applied to sustain electrode group UG1. As a result, the sustain pulse voltage Vs is added to the wall voltage on the scan electrode SCi and the wall voltage on the sustain electrode SUi in the discharge cells that produced the address discharge, and the voltage difference of the scan electrode SCi and the sustain electrode SUi exceeds the discharge start voltage. A sustain discharge is therefore produced between the scan electrode SCi and sustain electrode SUi, and the resulting UV light causes the phosphor layer 35 to emit. A negative wall voltage accumulates on the scan electrode SCi, and a positive wall voltage accumulates on the sustain electrode SUi. In address period Tw1, a sustain discharge is not produced in the discharge cells that did not produce an address discharge, and the wall voltage is sustained at the end of the initialization period Tin.

Voltage 0 (V) is then applied to the scan electrode group SG1, and positive sustain pulse voltage Vs is applied to sustain electrode group UG1. As a result, because in the discharge cells that produced a sustain discharge the voltage difference between the sustain electrode SUi and the scan electrode SCi exceeds the discharge start voltage, a sustain discharge is again produced between the sustain electrode SUi and scan electrode SCi, and a negative wall voltage is stored on the sustain electrode SUi and a positive wall voltage is stored on the scan electrode SCi. Thereafter, a sustain pulse is alternately applied to the scan electrode group SG1 and sustain electrode group UG1, and a potential difference is applied between the electrodes of the display electrode pairs, to continuously produce a sustain discharge in the discharge cells that produced an address discharge in the address period Tw1, and the discharge cells emit.

An erase period Te is provided after the sustain period Ts1. In the erase period Te a so-called narrow pulse width voltage difference is applied between the scan electrodes SC1-SCn and sustain electrodes SU1-SUn, and the wall voltage on the scan electrodes SCi and sustain electrodes SUi is erased while leaving a positive wall voltage on the data electrodes Dj.

The address period Tw1 of subfield SF2 of the display electrode pair group DG1 is described next.

A positive specific voltage Ve2 is applied to the sustain electrode group UG1. Next, as in the address period Tw1 of subfield SF1, a scan pulse is sequentially applied to the scan electrode group SG1, and address pulse is applied to the data electrodes Dj, and the discharge cells on lines 1 to 1080 are addressed.

Address period Tw1 of subfield SF2 in display electrode pair group DG1 corresponds to the sustain period Ts1 of subfield SF1 in the display electrode pair group DG2. More specifically, 60 sustain pulses are alternately applied one at a time to the scan electrode group SG2 and sustain electrode group UG2 to produce an address discharge and cause the discharge cells to emit.

In the erase period Te following the sustain period Ts1, a voltage difference with a narrow pulse width is applied between the scan electrode group SG2 and sustain electrode group UG2, and the wall voltage on the scan electrode SCi and sustain electrode SUi is erased while leaving a positive wall voltage on the data electrode Dj.

Operation continues thereafter in the address period Tw1 of subfield SF2 in display electrode pair group DG2, the address period Tw1 of subfield SF3 in display electrode pair group DG1, and so forth to the address period Tw1 of subfield SF10 in display electrode pair group DG2, and the sustain period Ts10 and erase period Te of subfield SF10 in the last display electrode pair group DG2 to complete one field period Tf.

The timing of the scan pulse and address pulse is thus set so that after the initialization period Tin the address operation runs continuously on either display electrode pair group DG1 or DG2. More specifically, as shown in equation (6), one field period Tf is greater than or equal to the sum of the initialization period Tin, the total write time Tw of the subfields SF1-SF10 (Tw×10), the sustain period Ts10 of subfield SF10, and the erase period Te of subfield SF10.

Tf≧(Tin+Tw×10+Ts10+Te) (6)

The sustain period Ts1-Ts9 and erase period Te of subfields SF1-SF9 are temporally parallel to the total write time Tw of subfields SF1-SF10 (Tw×10), and can therefore practically be ignored.

As a result, ten subfields SF1-SF10 can be set in one field period Tf. As described above, the number of subfields SF1-SF10 is the maximum number that can be set in one field period Tf.

As described above, one field period Tf ends after the sustain period Ts10 and erase period Te of display electrode pair group DG2 (see equation (6)). As a result, sustain period Ts10 in equation (6) can be shortened by inserting a sustain period Ts10 with the lowest brightness weight in the last subfield SF10.

Note that as described above a voltage difference with a narrow pulse width is applied in the erase period Te between the scan electrodes SC1-SCn and sustain electrodes SU1-SUn to erase the wall voltage, and the erase period Te is ignored when determining the subfield configuration and display electrode pair group count N. The address operation also continues even if during the erase period Te of one of the display electrode pair groups DG1, DG2. However, an erase period Te is required for the erase operation, and the address operation preferably does not execute during the erase period Te of either display electrode pair group DG1, DG2.

The plasma display panel drive circuit is described next.

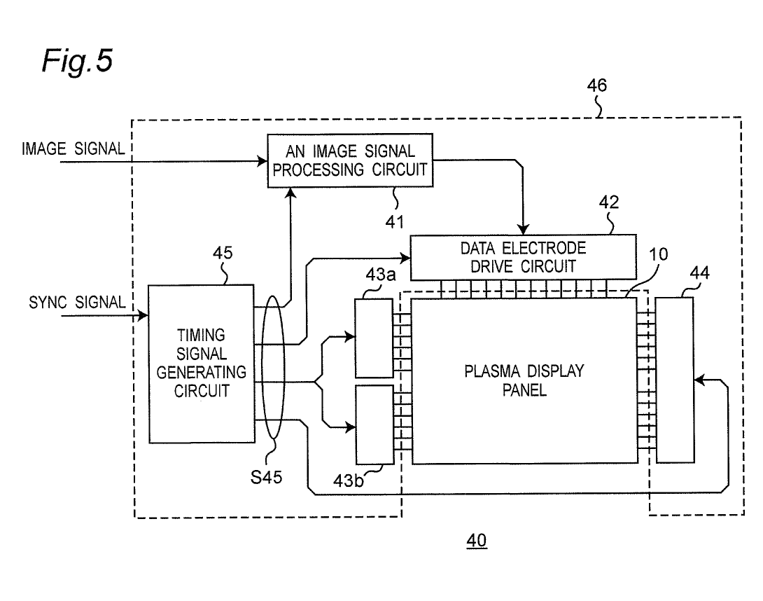

FIG. 5 is a block diagram of the plasma display device 40. The plasma display device 40 includes a plasma display panel drive circuit 46 and panel 10. The plasma display panel drive circuit 46 includes an image signal processing circuit 41, data electrode drive circuit 42, scan electrode drive circuit 43a, scan electrode drive circuit 43b, sustain electrode drive circuit 44, timing signal generating circuit 45, and a power supply circuit (not shown in the figure) that supplies power to the other circuit blocks.

The timing signal generating circuit 45 generates and supplies timing signals S45 to control operation of other circuits based on the horizontal synchronization signal and vertical synchronization signal of the image signal.

The image signal processing circuit 41 converts the image signal to image data denoting emit and non-emit states in each subfield based on the timing signals S45.

The data electrode drive circuit 42 has m switches for applying voltage Vd or voltage 0 (V) to the m data electrodes D1-Dm. Based on the timing signals S45, the data electrode drive circuit 42 converts the image data output from the image signal processing circuit 41 to address pulses corresponding to data electrodes D1-Dm, and applies the address pulses to the data electrodes D1-Dm.

Scan electrode drive circuit 43a drives the scan electrode group SG1 based on the timing signal S45, and scan electrode drive circuit 43b drives scan electrode group SG2 based on timing signal S45.

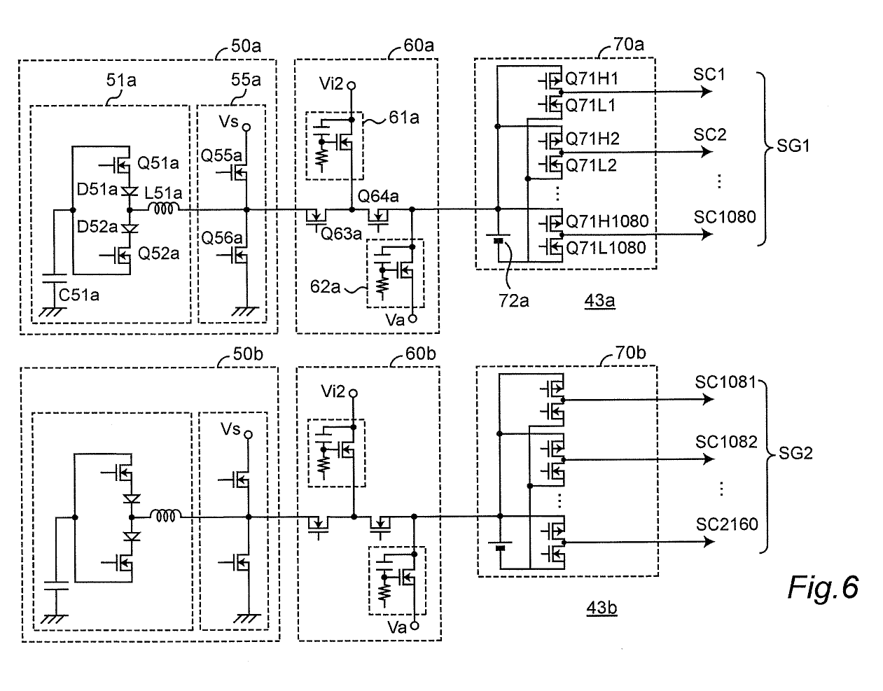

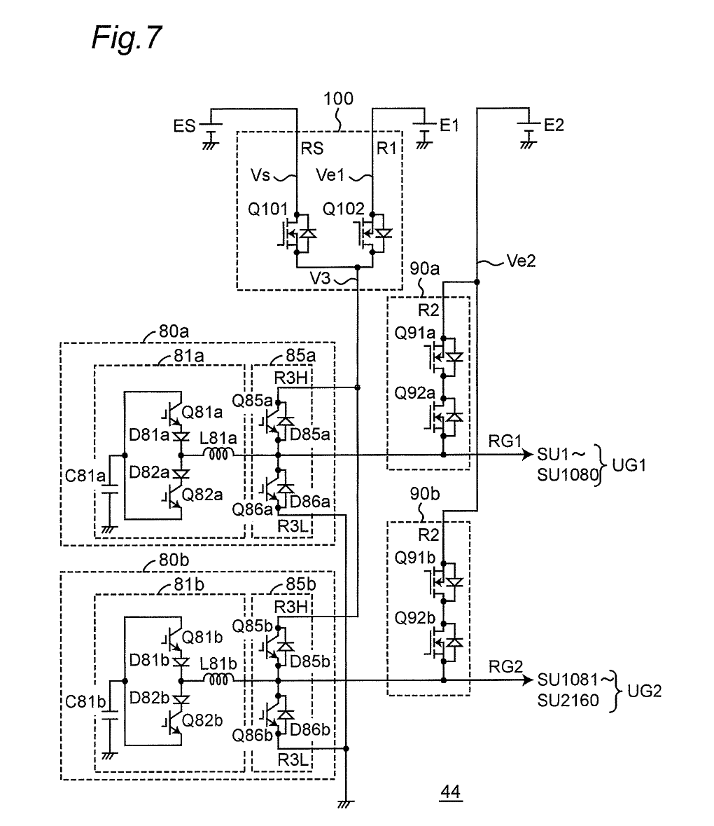

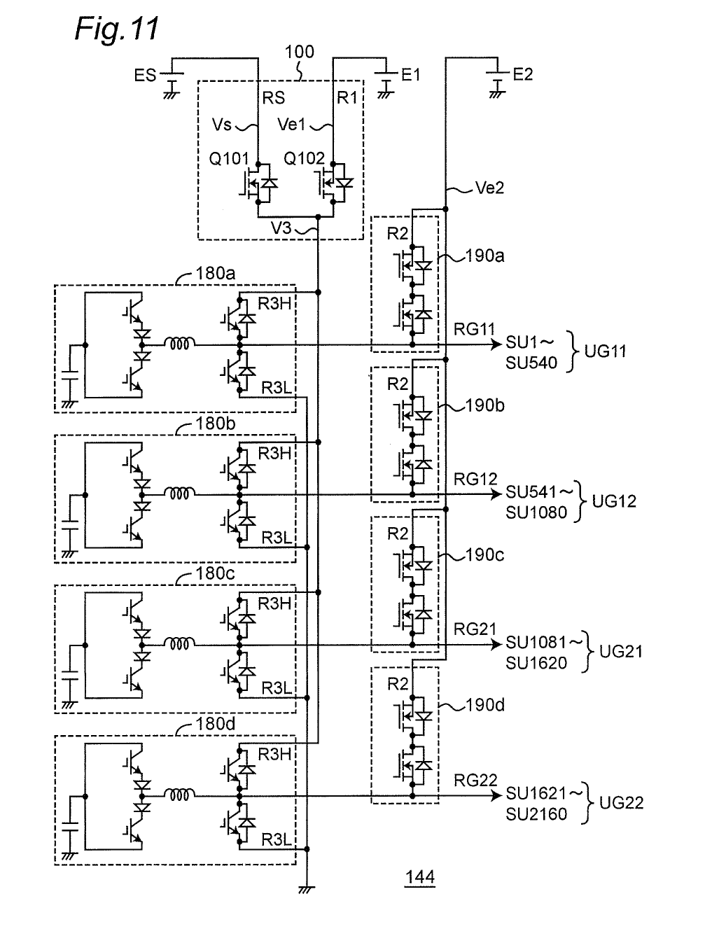

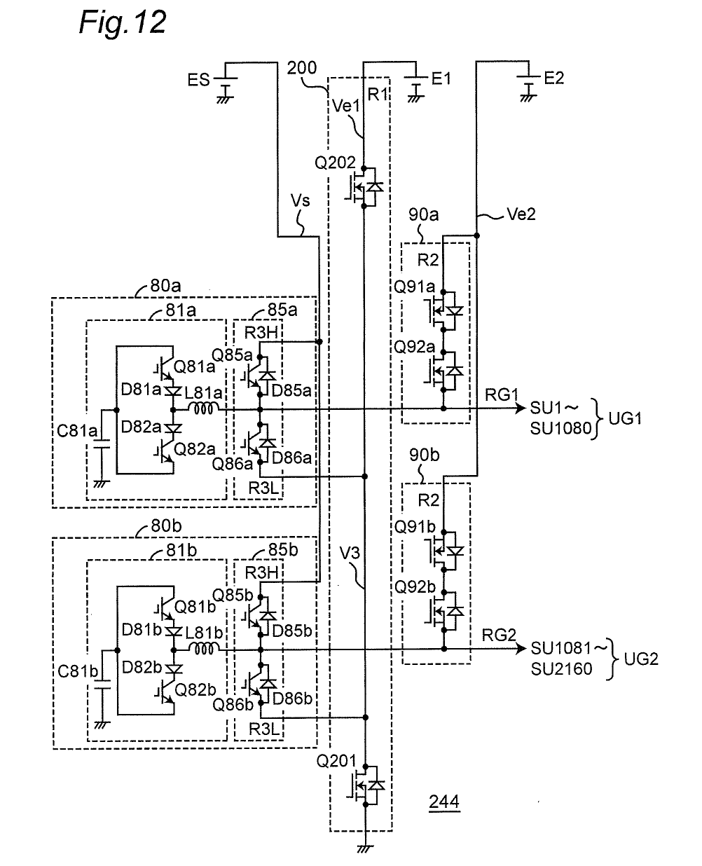

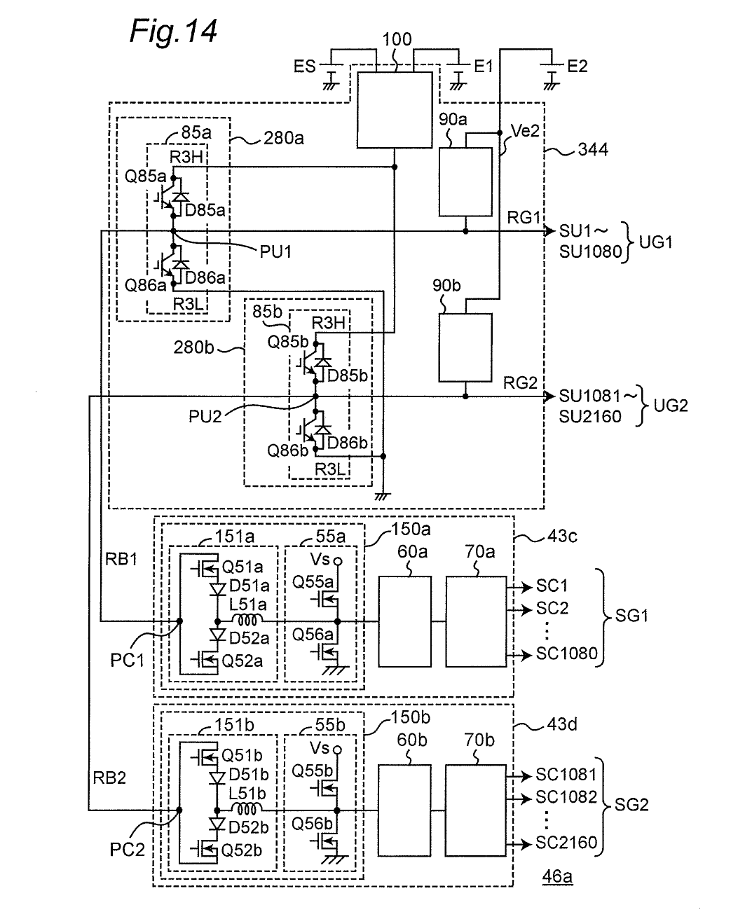

The sustain electrode drive circuit 44 drives sustain electrode groups UG1, UG2 based on the timing signal S45. Note that lines for the timing signals S45 from the timing signal generating circuit 45 are omitted for brevity in the exemplary circuit diagrams of the plasma display panel drive circuits 46, 46a according to the preferred embodiments shown in FIG. 6, FIG. 7, FIG. 11, FIG. 12, and FIG. 14.

FIG. 6 is a circuit diagram of the scan electrode drive circuits 43a and 43b of the plasma display panel drive circuit 46. The scan electrode drive circuit 43a includes a sustain pulse generating circuit 50a, initialization signal generating circuit 60a, and scan pulse generating circuit 70a.

The sustain pulse generating circuit 50a has an energy recovery unit 51a, and a voltage clamp circuit 55a, and applies sustain pulses to the scan electrode group SG1.

The energy recovery unit 51a includes a energy recovery capacitor C51a, switches Q51a, Q52a, reverse current blocking diodes D51a and D52a, and resonance inductor L51a. One end of capacitor C51a goes to ground, and the other end is connected to one side of switch Q51a and one side of switch Q52a. The other side of switch Q51a is connected to the anode of diode D51a, and the other side of switch Q52a is connected to the cathode of diode D52a. The cathode of diode D51a and the anode of diode D52a are connected in common to one side of inductor L51a, and the other side of inductor L51a is connected to a node between switch Q55a and switch Q56a of voltage clamp circuit 55a.

The energy recovery unit 51a LC resonates with inductor L51a and the 1080 interelectrode capacitances between the scan electrode group SG1 and sustain electrode group UG1 of display electrode pair group DG1, and raises and lowers the sustain pulses. When the sustain pulse rises, the energy recovery unit 51a supplies the charge (or power) stored in the energy recovery capacitor C51a through switch Q51a, diode D51a, inductor L51a, initialization signal generating circuit 60a, scan pulse generating circuit 70a, and scan electrode group SG1 to the 1080 interelectrode capacitances.

When the sustain pulse falls, the energy recovery unit 51a recovers the charge (or power) accumulated in the 1080 interelectrode capacitances from the scan electrode group SG1 through the scan pulse generating circuit 70a, initialization signal generating circuit 60a, inductor L51a, diode D52a, and switch Q52a to the energy recovery capacitor C51a. Because the energy recovery unit 51a thus drives the scan electrode group SG1 by means of LC resonance without supplying power from the power supply, power consumption is ideally 0. Note that the capacity of the energy recovery capacitor C51a is sufficiently greater than the 1080 interelectrode capacitances, and to function as the power supply of the energy recovery unit 51a is charged to approximately Vs/2 or half the supply voltage Vs supplied for a sustain discharge.

The voltage clamp circuit 55a has switches Q55a, Q56a. The scan electrode group SG1 is connected to the power supply through switch Q55a, and is clamped to the supply voltage Vs when switch Q55a turns on.

Scan electrode group SG1 goes to ground through switch Q56a, and is clamped to voltage 0 (V) when switch Q56a turns on.

The supply voltage Vs corresponds to the initial pulse voltage of the sustain pulse, and voltage 0 (V) corresponds to the reference voltage of the sustain pulse.

The voltage clamp circuit 55a alternately clamps the scan electrode group SG1 to the initial pulse voltage of the sustain pulse and the pulse reference voltage in the sustain period to apply sustain pulses to the scan electrode group SG1. The impedance of the voltage clamp circuit 55a is low when voltage is applied, and can stably pass the large discharge current of a strong sustain discharge.

The sustain pulse generating circuit 50a generates sustain pulses by controlling switches Q51a, Q52a, Q55a, Q56a based on timing signals S45, and applies sustain pulses to the scan electrode group SG1 through initialization signal generating circuit 60a and scan pulse generating circuit 70a. Note that these switches Q51a, Q52a, Q55a, Q56a can be rendered using a MOSFET (Metal Oxide Semiconductor Field Effect Transistor), IGBT (Insulated Gate Bipolar Transistor), or other type of transistor device. FIG. 6 shows a circuit configuration using MOSFET devices as the switches. Note that the body diode of the MOSFETs are omitted from the figures for brevity.

The initialization signal generating circuit 60a includes Miller integrator 61a, Miller integrator 62a, switch Q63a, and switch Q64a.

Miller integrator 61a applies a gradually rising slope waveform voltage to scan electrode group SG1 in the initialization period Tin.

Miller integrator 62a applies a gradually falling slope voltage to scan electrode group SG1 in initialization period Tin. Switches Q63a, Q64a are separation switches, and are provided to prevent reverse current flow through the parasitic diodes of switches in the sustain pulse generating circuit 50a and initialization signal generating circuit 60a. The initialization signal generating circuit 60a applies an initialization pulse to the scan electrode group SG1 by controlling Miller integrator 61a, 62a and switch Q63a, Q64a based on timing signal S45.

The scan pulse generating circuit 70a has switches Q71H1 and Q71L1 for applying a negative voltage Va scan pulse to scan electrode SC1; switches Q71H2 and Q71L2 for applying the scan pulse to scan electrode SC2, and so forth to switches Q71H1080 and Q71L1080 for applying scan pulses to scan electrode SC1080. The scan pulse generating circuit 70a also has a power supply 72a for generating the negative voltage Va. The scan pulse generating circuit 70a applies negative voltage Va scan pulses to the scan electrode SCi (i=1 to 1080) by changing switch Q71Hi from on to off and simultaneously changing switch Q71Li from off to on based on timing signal S45. Scan pulses are thus sequentially applied to scan electrode group SG1 by the scan pulse generating circuit 70a controlling switches Q71H1-Q71H1080 and Q71L1-Q71L1080 based on timing signal S45.

The scan electrode drive circuit 43b is configured identically to scan electrode drive circuit 43a, and applies sustain pulses, initialization pulses, and scan pulses to scan electrode group SG2.

The sustain electrode drive circuit thus includes a sustain pulse generating circuit for each of plural display electrode pair groups to apply sustain pulses to the sustain electrodes of each display electrode pair group; a specific voltage application circuit disposed for each of the plural display electrode pair group to apply a specific voltage to the sustain electrodes of the display electrode pair groups; and a voltage selection circuit that selectively applies one of plural voltages to each of the plural sustain pulse generating circuits. The specific voltage application circuit is also called a constant voltage generating circuit. The specific voltage is also called a constant voltage. A constant voltage generating circuit applies a constant voltage to the sustain electrodes of the display electrode pair group.

FIG. 7 is a circuit diagram of the sustain electrode drive circuit 44 of the plasma display panel drive circuit 46.

As described above, the 2160 display electrode pairs including the scan electrodes SC1-SC2160 and sustain electrodes SU1-SU2160 of the panel 10 are divided into display electrode pair groups DG1, DG2. Display electrode pair group DG1 includes scan electrode group SG1 and sustain electrode group UG1, and display electrode pair group DG2 includes scan electrode group SG2 and sustain electrode group UG2. More specifically, the plural sustain electrodes SU1-SU2160 of the plasma display panel 10 are divided into sustain electrode group UG1 and sustain electrode group UG2. Sustain electrode drive circuit 44 applies sustain pulses in sustain periods Ts1-Ts10 to sustain electrode group UG1 and sustain electrode group UG2.

The sustain electrode drive circuit 44 includes two sustain pulse generating circuits 80a, 80b, two specific voltage application circuits 90a, 90b, one voltage selection circuit 100, electrode path RG1, and electrode path RG2. The sustain electrode drive circuit 44 is connected through electrode path RG1 to sustain electrode group UG1, and through electrode path RG2 to sustain electrode group UG2. Electrode path RG1 in sustain electrode drive circuit 44 is the output path to the sustain electrode group UG1, or the input path from sustain electrode group UG1. In sustain electrode drive circuit 44, the electrode path RG2 is the output path to the sustain electrode group UG2 or the input path from the sustain electrode group UG2.

The voltage selection circuit 100 includes power supply path RS, power supply path R1, switch Q101 and switch Q102. Specific voltage source ES generates specific voltage Vs, and power supply path RS receives the specific voltage Vs. Likewise, specific voltage source E1 generates specific voltage Ve1, and supply path R1 receives the specific voltage Ve1. Switch Q101 is connected between power supply path RS and sustain pulse generating circuits 80a and 80b, and switch Q102 is connected between power supply path R1 and sustain pulse generating circuits 80a and 80b. The power supply path may be a power supply connector.

Voltage selection circuit 100 selects one specific voltage from among a plurality of specific voltages, and outputs selected voltage V3 representing the selected voltage. For example, voltage selection circuit 100 may select either specific voltage Vs or Ve1, and output selected voltage V3. If switch Q101 is ON, the voltage selection circuit 100 selects specific voltage Vs, and sets selected voltage V3 to specific voltage Vs. However, if switch Q102 is ON, voltage selection circuit 100 selects specific voltage Ve1, and sets selected voltage V3 to specific voltage Ve1. The voltage selection circuit 100 thus generates selected voltage V3 as a result of switch Q101 and Q102 being controlled based on timing signal S45.

Note that switch Q102 is disposed to pass current from sustain pulse generating circuits 80a and 80b through power supply path R1 to specific voltage source E1. However, if current only flows from specific voltage source E1 through power supply path R1 to sustain pulse generating circuits 80a and 80b, switch Q102 may be replaced with a diode.

The sustain pulse generating circuit 80a has a energy recovery unit 81a and voltage clamp circuit 85a. The energy recovery unit 81a includes energy recovery capacitor C81a, switches Q81a and Q82a, reverse current blocking diodes D81a and D82a, and resonance inductor L81a. Voltage clamp circuit 85a includes high voltage path R3H, low voltage path R3L, switch Q85a and Q86a, and diode D85a and D86a. Switch Q85a is an example of a high voltage switch, and switch Q86a is an example of a low voltage switch.

One end of capacitor C81a goes to ground, and the other end is connected between one end of switch Q81a and one end of switch Q82a. The other end of switch Q81a is connected to the anode of diode D81a, and the other end of switch Q82a is connected to the cathode of diode D82a. The cathode of diode D81a and the anode of diode D82a are connected to one side of inductor L81a. The other end of inductor L81a is connected to a common node between switch Q85a and switch Q86a in voltage clamp circuit 85a.

Likewise, sustain pulse generating circuit 80b has a energy recovery unit 81b and voltage clamp circuit 85b. Energy recovery unit 81b includes energy recovery capacitor C81b, switch Q81b and Q82b, reverse current blocking diodes D81b and D82b, and resonance inductor L81b. Voltage clamp circuit 85b includes high voltage path R3H, low voltage path R3L, switch Q85b and Q86b, and diodes D85b and D86b. Switch Q85b is an example of a high voltage switch, and switch Q86b is an example of a low voltage switch.

MOSFET, IBGT, or other type of transistor device can be used for the switches in sustain pulse generating circuits 80a, 80b. FIG. 7 shows a circuit configuration using IGBT devices. Particularly when IGBT devices are used as the switches Q85a, Q86a, Q85b, Q86b in voltage clamp circuits 85a, 85b, a current path in the opposite direction as the forward path of the controlled current (that is, the direction of forward flow from the collector to the emitter) must be provided to assure the required reverse voltage resistance of the IGBT devices. As a result, diodes D85a, D86a, D85b, D86b are disposed parallel to switches Q85a, Q86a, Q85b, Q86b, respectively, so that forward current flows in mutually opposite directions through the respective diodes and switches.

Although not shown in FIG. 7, diodes may be similarly parallel connected to switches Q81a, Q82a, Q81b, Q82b for IGBT protection.

In voltage clamp circuit 85a, the parallel circuit of switch Q85a and diode D85a is connected between high voltage path R3H and electrode path RG1, and the parallel circuit of switch Q86a and diode D86a is connected between low voltage path R3L and electrode path RG1. Likewise, in voltage clamp circuit 85b, the parallel circuit of switch Q85b and diode D85b is connected between high voltage path R3H and electrode path RG2, and the parallel circuit of switch Q86b and diode D86b is connected between low voltage path R3L and electrode path RG2. High voltage path R3H is connected to switch Q101 and Q102 of voltage selection circuit 100, and low voltage path R3L goes to ground.

The operation of sustain pulse generating circuit 80a is the same as the operation of sustain pulse generating circuit 50a.

More specifically, at the sustain pulse rise, energy recovery unit 81a supplies the charge (or power) stored in energy recovery capacitor C81a through switch Q81a, diode D81a, inductor L81a, and electrode path RG1 to the interelectrode capacitances of of the sustain electrodes SU1-SU1080 in sustain electrode group UG1. When the sustain pulse falls, the energy recovery unit 81a recovers the charge (or power) stored in the interelectrode capacitances of sustain electrodes SU1-SU1080 through electrode path RG1, inductor L81a, diode D82a, and switch Q82a to energy recovery capacitor C81a.

In voltage clamp circuit 85a, high voltage path R3H receives selected voltage V3, and low voltage path R3L receives specific voltage 0 (V). When switch Q85a is ON, sustain electrode group UG1 is clamped to selected voltage V3 of high voltage path R3H. When the selected voltage V3 is specific voltage Vs, sustain electrode group UG1 is clamped to specific voltage Vs. When selected voltage V3 is specific voltage Ve1, sustain electrode group UG1 is clamped to specific voltage Ve1. When switch Q86a is ON, sustain electrode group UG1 is clamped to specific voltage 0 (V).

The specific voltage Vs corresponds to the pulse starting voltage of the sustain pulses, and specific voltage 0 (V) corresponds to the reference voltage of the sustain pulses. By alternately clamping the sustain electrode group during the sustain period to the pulse starting voltage of the sustain pulses and the reference voltage, the voltage clamp circuit 85a applies sustain pulses to the sustain electrode group. The impedance of the voltage clamp circuit 85a when voltage is applied is low, and the voltage clamp circuit 85a can pass the large discharge current of a strong sustain discharge stably.

The sustain pulse generating circuit 80a thus generates sustain pulses by controlling switches Q81a, Q82a, Q85a, Q86a based on timing signal S45, and applies sustain pulses through electrode path RG1 to sustain electrode group UG1. In addition, sustain pulse generating circuit 80a receives specific voltage Ve1 from voltage selection circuit 100 on high voltage path R3H, and applies specific voltage Ve1 through electrode path RG1 to sustain electrode group UG1.

The sustain pulse generating circuit 80b operates the same way as sustain pulse generating circuit 80a. More specifically, sustain pulse generating circuit 80b generates sustain pulses by repeatedly generating the pulse starting voltage and reference voltage, and applying the voltages through electrode path RG2 to the sustain electrode group UG2. In addition, sustain pulse generating circuit 80b receives specific voltage Ve1 from voltage selection circuit 100 on the high voltage path R3H, and applies the voltage through electrode path RG2 to sustain electrode group UG2.

Specific voltage application circuit 90a includes power supply path R2, switch Q91a, and switch Q92a. Specific voltage source E2 generates specific voltage Ve2, and power supply path R2 receives specific voltage Ve2. Switch Q91a and switch Q92a are two-way switches connected in series so that the forward directions of the controlled currents (that is, the forward current flow from drain to source or from collector to emitter) are opposite. The serial circuit of switch Q91a and switch Q92a is connected between power supply path R2 and electrode path RG1. The specific voltage application circuit 90a is on when switch Q91a and switch Q92a are simultaneously on, and off when both switches are off. When specific voltage application circuit 90a is on, specific voltage Ve2 is applied through electrode path RG1 to sustain electrode group UG1. When specific voltage application circuit 90a is off, power supply path R2 and sustain electrode group UG1 are electrically isolated. The specific voltage application circuit 90a thus applies specific voltage Ve2 through electrode path RG1 to sustain electrode group UG1 as controlled based on timing signal S45.

Specific voltage application circuit 90b similarly includes power supply path R2, switch Q91b, and switch Q92b. Switch Q91b and switch Q92b are two-way switches connected in series so that the forward directions of the controlled currents are opposite. The serial circuit of switch Q91b and switch Q92b is connected between power supply path R2 and electrode path RG2. The specific voltage application circuit 90b is on when switch Q91b and switch Q92b are simultaneously on, and off when both switches are off. When specific voltage application circuit 90b is on, specific voltage Ve2 is applied through electrode path RG2 to sustain electrode group UG2. When specific voltage application circuit 90b is off, power supply path R2 and sustain electrode group UG2 are electrically isolated. The specific voltage application circuit 90b thus applies specific voltage Ve2 through electrode path RG2 to sustain electrode group UG2 as controlled based on timing signal S45.

Note that the switches in voltage selection circuit 100 and specific voltage application circuits 90a, 90b can also be rendered using MOSFET or IGBT transistor devices. FIG. 7 shows a circuit configuration using MOSFET devices. When IGBT devices are used as the switches, a current path in the opposite direction as the forward path of the controlled current (that is, the direction of forward flow from the collector to the emitter) must be provided to assure the required reverse voltage resistance of the IGBT devices. As a result, a diode is therefore preferably disposed parallel to the IGBT device respectively, so that forward current flows in mutually opposite directions through the respective diodes and switches. Note that the body diodes of the MOSFET devices are shown in FIG. 7.

Note, further, that switches Q91a, Q91b can be replaced by diodes if current only flows from specific voltage source E2 to sustain electrode groups UG1 or UG2.

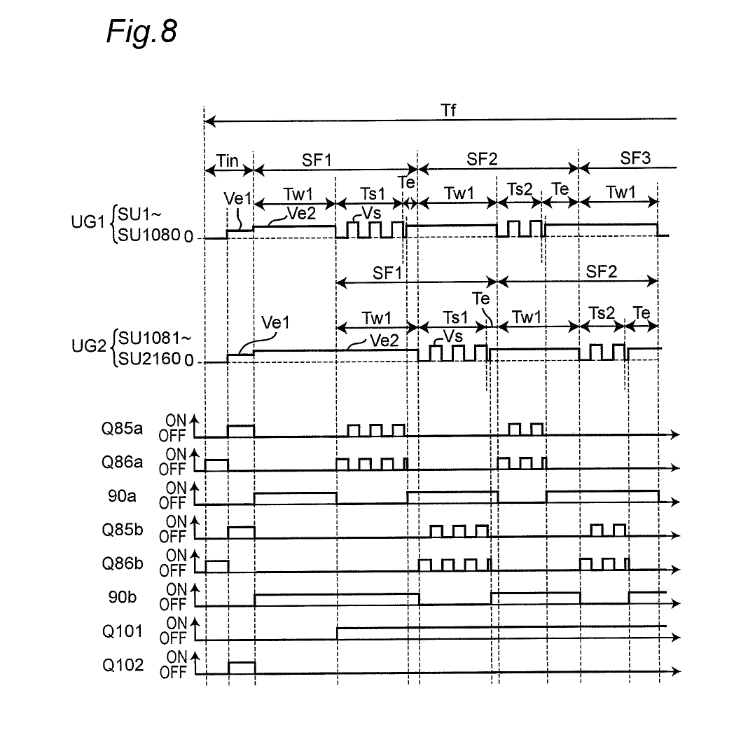

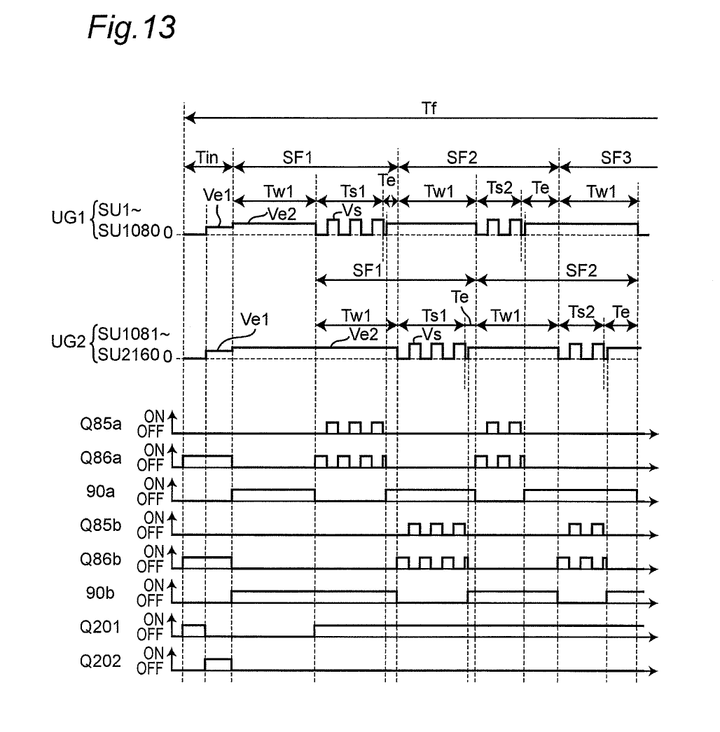

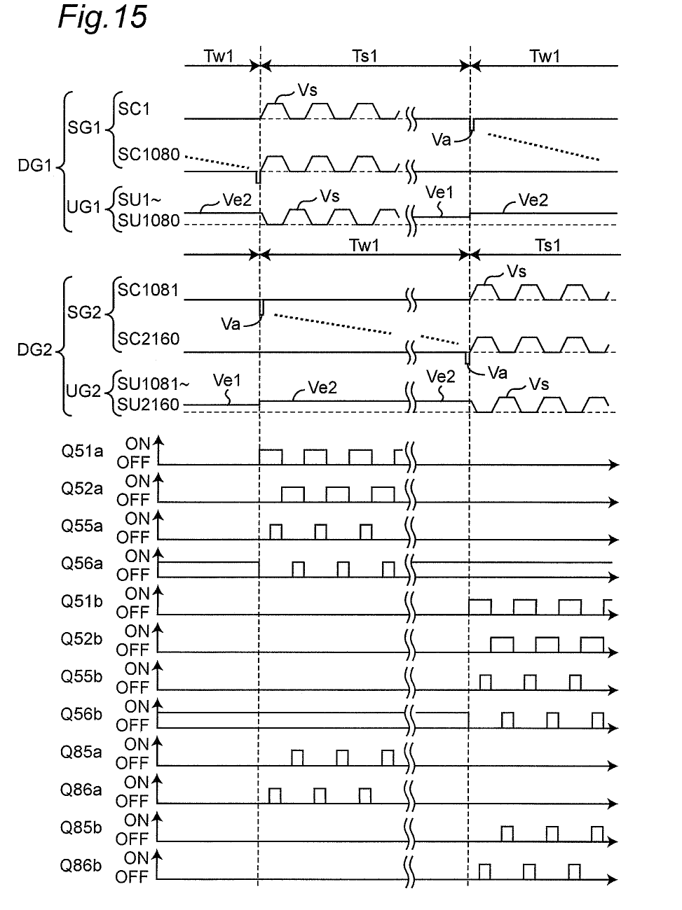

FIG. 8 is a waveform diagram showing the operation of the sustain electrode drive circuit 44 of the plasma display panel drive circuit 46. The top half of FIG. 8 shows the drive voltage signals applied to sustain electrode group UG1 and sustain electrode group UG2. The bottom half of FIG. 8 shows the on/off states of switches Q85a, Q86a, Q85b, and Q86b, specific voltage application circuit 90a and 90b, and switches Q101 and Q102 based on timing signals S45. These on/off states are denoted ON and OFF in FIG. 8, FIG. 13, and FIG. 15.

To apply voltage 0 (V) to sustain electrode groups UG1, UG2 in initialization period Tin, switch Q86a turns on and sustain electrode group UG1 goes to ground. Switch unit 86b also turns on at the same time so that sustain electrode group UG2 goes to ground.

Next, to apply specific voltage Ve1 to sustain electrode groups UG1, UG2, switches Q86a, Q86b are turned off. Switch Q102 then goes ON to supply specific voltage Ve1 to sustain pulse generating circuits 80a, 80b. Switch Q85a then goes ON to clamp sustain electrode group UG1 to specific voltage Ve1. At the same time, switch Q85b turns ON to clamp sustain electrode group UG2 to specific voltage Ve1.

In address period Tw1 of subfield SF1 in sustain electrode group UG1, switch Q85a turns OFF, specific voltage application circuit 90a turns ON, and specific voltage Ve2 is applied to sustain electrode group UG1. At the same time, switch Q85b turns OFF, specific voltage application circuit 90b turns ON, and specific voltage Ve2 is also applied to sustain electrode group UG2.

In the following sustain period Ts1 of subfield SF1 in sustain electrode group UG1, switch Q101 turns ON, and specific voltage Vs is supplied to sustain pulse generating circuits 80a, 80b. Specific voltage application circuit 90a turns OFF, and the sustain pulses generated by sustain pulse generating circuit 80a are applied to sustain electrode group UG1.

To output sustain pulses from sustain pulse generating circuit 80a, switch Q81a, Q85a, Q86a are turned OFF, then switch Q82a turns ON, and the voltage of sustain electrode group UG1 is reduced to near specific voltage 0 (V) by LC resonance. Next, switch Q86a turns ON, and sustain electrode group UG1 is clamped to specific voltage 0 (V). Next, switches Q82a, Q86a turn OFF, switch Q81a turns ON, and the voltage of sustain electrode group UG1 is boosted to near specific voltage Vs. Next, switch Q85a turns ON, and sustain electrode group UG1 is clamped to specific voltage Vs. By repeating the foregoing operation, sustain pulse generating circuit 80a can be made to continue generating sustain pulses.

Because the sustain electrode group UG2 is in the address period Tw1 of subfield SF1 at this time, specific voltage Ve2 continues to be applied to sustain electrode group UG2.

In the following erase period Te of subfield SF1 in the sustain electrode group UG1, switches Q81a, Q82a, Q85a, Q86a turn OFF, specific voltage application circuit 90a turns ON, and specific voltage Ve2 is applied to sustain electrode group UG1. Thereafter, the switches continue switching on/off in the address period Tw1 of subfield SF2 in sustain electrode group UG1.

In the address period Tw1 of subfield SF2 in sustain electrode group UG1, sustain electrode group UG2 is in the sustain period Ts1 of subfield SF1. As a result, specific voltage application circuit 90b turns OFF, and the sustain pulses generated by sustain pulse generating circuit 80b are applied to sustain electrode group UG2.

This operation thereafter continues to turn the switches of the corresponding sustain pulse generating circuits off, turn the switches of the specific voltage application circuit on, and apply specific voltage Ve2 to the sustain electrodes of the sustain electrode group in the address period Tw1. In addition, the corresponding specific voltage application circuit is turned off, and the switches of the sustain pulse generating circuit are controlled to apply sustain pulses to the sustain electrodes of the sustain electrode group in the sustain period.

By repeating this operation, the drive voltage signals shown in FIG. 8 can be applied to the sustain electrodes of sustain electrode groups UG1, UG2.

As described above, the sustain electrode drive circuit 44 according to the first embodiment of the invention has a voltage selection circuit 100 that selects one specific voltage from between specific voltage Vs and specific voltage Ve1, and applies the selected voltage to two sustain pulse generating circuits 80a, 80b. Compared with a configuration having the same number of sustain electrode drive circuits as display electrode pair groups, the configuration according to the first embodiment of the invention can reduce the number of switches and thereby render a simpler sustain electrode drive circuit.

If there are the same number of sustain electrode drive circuits as the number of display electrode pair groups, two switches, for a total of four switches, are required to supply specific voltage Ve1 to the sustain electrode drive circuits. However, by adding the two switches Q101 and Q102 of the voltage selection circuit 100 according to the first embodiment of the invention, the foregoing four switches can be eliminated and the number of required switches can be reduced by two.

The foregoing first embodiment of the invention describes a configuration in which the 2160 display electrode pairs are divided vertically into two display electrode pair groups. The invention is not so limited, however, and there may be three or more display electrode pair groups. In addition, as the number of display electrode pair groups increases, the effect of reducing the number of switches increases.

An embodiment in which there are four display electrode pair groups is described below.

### Embodiment 2

The differences between this second embodiment and the foregoing first embodiment of the invention are described below. Other aspects of the configuration, operation, and effect of this second embodiment are the same as the first embodiment, and further description thereof is thus omitted.

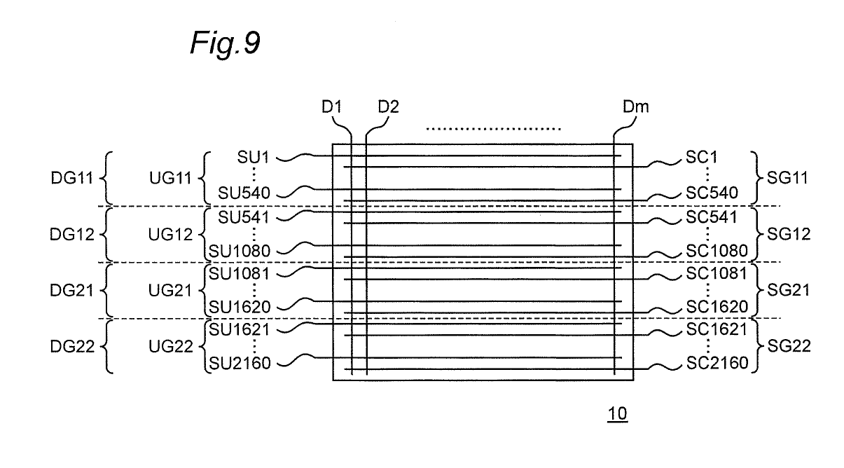

FIG. 9 shows the electrode arrangement of the panel 10 in the plasma display device 40. In this second embodiment of the invention the panel is divided vertically into four parts rendering four display electrode pair groups. In order from the display electrode pair group at the top of the panel are display electrode pair group DG11, display electrode pair group DG12, display electrode pair group DG21, and display electrode pair group DG22. In addition, the 540 scan electrodes SC1-SC540 render scan electrode group SG11, and the 540 sustain electrodes SU1-SU540 render sustain electrode group UG11.

The 540 scan electrodes SC541-SC1080 render scan electrode group SG12, and the 540 sustain electrodes SU541-SU1080 render sustain electrode group UG12. The 540 scan electrodes SC1081-SC1620 render scan electrode group SG21, and the 540 sustain electrodes SU1081-SU1620 render sustain electrode group UG21.

The 540 scan electrodes SC1621-SC2160 render scan electrode group SG22, and the 540 sustain electrodes SU1621-SU2160 render sustain electrode group UG22.

More specifically, scan electrode group SG11 and sustain electrode group UG11 belong to display electrode pair group DG11, and scan electrode group SG12 and sustain electrode group UG12 belong to display electrode pair group DG12. In addition, scan electrode group SG21 and sustain electrode group UG21 belong to display electrode pair group DG21, and scan electrode group SG22 and sustain electrode group UG22 belong to display electrode pair group DG22.

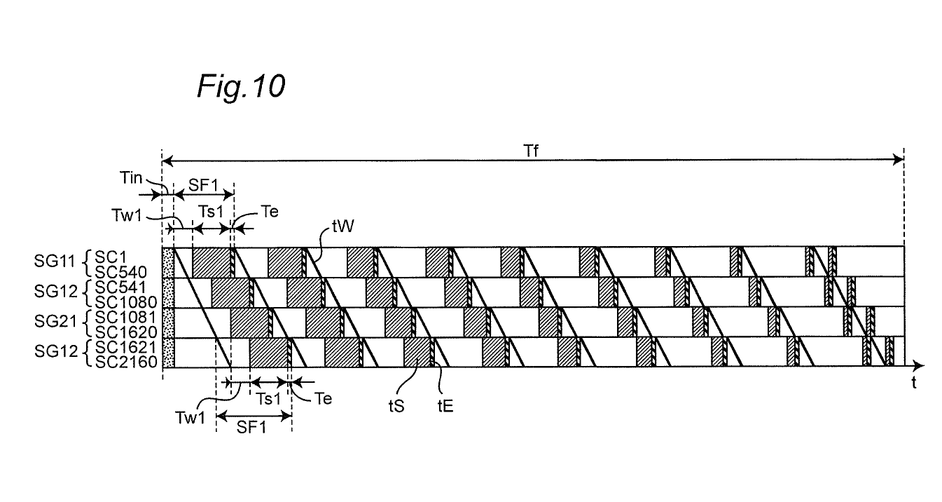

FIG. 10 is a timing chart showing the subfield configuration of the plasma display device 40. The y-axis in FIG. 10 shows the scan electrodes SC1-SC2160, and the x-axis shows time t. The timing tW denoting the timing of the address (write) operation is indicated by the solid bold lines. The sustain period timing tS denoting the timing of the sustain period is indicated by the light shading. The erase period timing tE denoting the timing of the erase period is denoted by the heavy shading. As shown in the figure, by increasing number of display electrode pair groups, the sustain period Ts can be increased compared with the timing shown in FIG. 3. As a result, the number of sustain pulses that can be applied to the display electrode pairs can be increased, and panel brightness can be increased.

As shown in FIG. 10, the erase period Te is immediately before the address period of the next subfield. Drive is controlled so that one of the display electrode pair groups is always addressed in one field period Tf not including initialization period Tin and erase periods Te. In addition, so that the sustain period ends immediately before the erase period Te, an erase period is rendered between the sustain period and address period. By thus rendering an erase period immediately after the sustain period, an erase discharge can be applied using the priming produced by the sustain discharge, and a stable erase operation can be accomplished.

Note that in the second embodiment of the invention one field period Tf is 16.7 ms, the initialization period Tin is 500 μs, and the time required to address one scan electrode is 0.7 μs. Therefore, the total address period Tw, which is the time required to address all scan electrodes SC1-SC2160 once, is 1512 μs, and a maximum of 10 subfields can be secured. However, in this second embodiment of the invention, 110, 81, 55, 33, 20, 11, 6, 4, 2, and 1 sustain pulses are applied in each subfield. On average, the number of sustain pulses is slightly less than half that compared with the first embodiment. If the sustain pulse period is panel 10 μs, the maximum time Ts1 required to apply the sustain pulses is 10×110=1100 μs.

As a result, equation 2 is as follows.

N≧Tw/(Tw−Ts1)=3.67 (7)

Because the number of display electrode pair groups N is the smallest integer that satisfied equation 7, N=4. The display electrode pairs can therefore be divided into four display electrode pair groups, the number of sustain pulses can be increased slightly less than double compared with using two display electrode pair groups, and panel brightness can be increased.

FIG. 11 is a circuit diagram of the sustain electrode drive circuit 144 in the plasma display panel drive circuit 46. The sustain electrode drive circuit 144 has four sustain pulse generating circuits 180a, 180b, 180c, and 180d, four specific voltage application circuits 190a, 190b, 190c, and 190d, one voltage selection circuit 100, and 4 electrode paths RG11, RG12, RG21, and RG22. The sustain electrode drive circuit 144 is connected through electrode path RG11 to sustain electrode group UG11, through electrode path RG12 to sustain electrode group UG12, through electrode path RG21 to sustain electrode group UG21, and through electrode path RG22 to sustain electrode group UG22. The electrode path RG11 is, in sustain electrode drive circuit 144, the output path to sustain electrode group UG11 or the input path from sustain electrode group UG11. The electrode path RG12 is, in sustain electrode drive circuit 144, the output path to sustain electrode group UG12 or the input path from sustain electrode group UG12. Electrode path RG21 is, in sustain electrode drive circuit 144, the output path to sustain electrode group UG21 or the input path from sustain electrode group UG21. Electrode path RG22 is, in sustain electrode drive circuit 144, the output path to sustain electrode group UG22 or the input path from sustain electrode group UG22.

The voltage selection circuit 100 has the same configuration as the voltage selection circuit 100 according to the first embodiment of the invention, and operates the same. More specifically, voltage selection circuit 100 selects one specific voltage from either specific voltage Vs or Ve1, and supplies the selected specific voltage to high voltage path R3H.

The sustain pulse generating circuits 180a, 180b, 180c, 180d have the same configuration as the sustain pulse generating circuit 80a according to the first embodiment of the invention, and operate the same.

More specifically, sustain pulse generating circuits 180a, 180b, 180c, 180d produce sustain pulses by repeating and applying the pulse starting voltage and reference voltage to sustain electrode groups UG11, UG12, UG21, UG22. In addition, sustain pulse generating circuits 180a, 180b, 180c, 180d receive and apply specific voltage Ve1 from voltage selection circuit 100 on high voltage path R3H, to sustain electrode groups UG11, UG12, UG21, UG22, respectively.

The specific voltage application circuits 190a, 190b, 190c, 190d have the same configuration and operate the same as the specific voltage application circuit 90a according to the first embodiment of the invention. More specifically, when specific voltage application circuits 190a, 190b, 190c, 190d are ON, they supply specific voltage Ve2 to sustain electrode groups UG11, UG12, UG21, UG22, respectively. When specific voltage application circuits 190a, 190b, 190c, 190d are OFF, power supply path R2 is electrically isolated from sustain electrode group UG11, UG12, UG21, UG22, respectively.

Note that when specific voltage application circuits 190a, 190b, 190c, 190d pass current from specific voltage source E2 only to sustain electrode groups UG11, UG12, UG21, UG22, respectively, one of the switches may be replaced with a diode.

As described above, the sustain electrode drive circuit 144 according to the second embodiment of the invention has a voltage selection circuit 100 that selects and supplies one specific voltage from among specific voltage Vs and specific voltage Ve1, to four sustain pulse generating circuits 180a, 180b, 180c, 180d. This configuration can reduce the number of switches when compared with a configuration that has the same number of sustain electrode drive circuits as the number of display electrode pair groups, and achieves a simple sustain electrode drive circuit. If the number of display electrode pair groups and the number of sustain electrode drive circuits is the same, two switches are required to supply the specific voltage Ve1 to each of the sustain electrode drive circuits, requiring a total of eight switches. However, with this second embodiment of the invention, by adding the two switches Q101, Q102 to the configuration of the voltage selection circuit voltage selection circuit 100, the foregoing eight switches can be eliminated, reducing the number of switches by 6.

In the first and second embodiments of a sustain electrode drive circuit according to the invention, the voltage selection circuit 100 supplies specific voltage Vs or specific voltage Ve1 to the high voltage path R3H of the sustain pulse generating circuit. The invention is not limited to this configuration, however. More particularly, a sustain electrode drive circuit according to the third embodiment of the invention below describes a configuration having a voltage selection circuit that supplies specific voltage 0 (V) or specific voltage Ve1 to the low voltage path R3L of the sustain pulse generating circuit.

### Embodiment 3

As in the first embodiment, the third embodiment divides the panel vertically into two display electrode groups DG1, DG2. Scan electrodes SC1-SC1080 (more specifically, scan electrode group SG1) and sustain electrodes SU1-SU1080 (more specifically, sustain electrode group UG1) belong to display electrode pair group DG1, and scan electrodes SC1081-SC2160 (more specifically, scan electrode group SG2) and sustain electrodes SU1081-SU2160 (more specifically, sustain electrode group UG2) belong to display electrode pair group DG2.

FIG. 12 is a circuit diagram of the sustain electrode drive circuit 244 of the plasma display panel drive circuit 46. The sustain electrode drive circuit 244 has two sustain pulse generating circuits 80a and 80b, two specific voltage application circuits 90a and 90b, one voltage selection circuit 200, and two electrode paths RG1 and RG2. The sustain electrode drive circuit 244 shown in FIG. 12 differs from the sustain electrode drive circuit 44 shown in FIG. 7 in that the voltage selection circuit 100 differs from voltage selection circuit 200. In addition, in sustain electrode drive circuit 44 the high voltage path R3H is connected to voltage selection circuit 100, and low voltage path R3L goes to ground, and in sustain electrode drive circuit 244 the high voltage path R3H receives specific voltage Vs from specific voltage source ES, and low voltage path R3L is connected to voltage selection circuit 200. Other aspects of the configuration, operation, and effect of this embodiment are the same as in the first and second embodiments, and further description thereof is omitted below.

The voltage selection circuit 200 includes power supply path R1, switch Q201, and switch Q202. The specific voltage source E1 generates specific voltage Ve1, and power supply path R1 receives specific voltage Ve1. Switch Q201 is connected between ground and the sustain pulse generating circuits 80a and 80b, and switch Q202 is connected between power supply path R1 and sustain pulse generating circuits 80a and 80b.

The voltage selection circuit 200 selects one specific voltage from among plural specific voltages, and outputs selected voltage V3 representing the selected specific voltage. For example, the voltage selection circuit 200 selects one of specific voltage 0 (V) and specific voltage Ve1, and outputs selected voltage V3. When switch Q201 is ON, voltage selection circuit 200 selects specific voltage 0 (V), and sets selected voltage V3 to specific voltage 0 (V). When switch Q202 is ON, voltage selection circuit 200 selects specific voltage Ve1, and sets selected voltage V3 to specific voltage Ve1.

In the voltage clamp 85a, high voltage path R3H is connected to specific voltage source ES, and low voltage path R3L is connected to switch Q201 and Q202 in voltage selection circuit 200. The high voltage path R3H receives specific voltage Vs from specific voltage source ES, and low voltage path R3L receives selected voltage V3. When switch Q86a goes ON, sustain electrode group UG1 is clamped to selected voltage V3 on low voltage path R3L. Sustain electrode group UG1 is clamped to specific voltage 0 (V) when selected voltage V3 is specific voltage 0 (V), is clamped to specific voltage Ve1 and when selected voltage V3 is specific voltage Ve1. When switch Q85a is ON, sustain electrode group UG1 is clamped to specific voltage Vs.

Specific voltage Vs corresponds to the sustain pulse starting voltage, and specific voltage 0 (V) corresponds to the sustain pulse reference voltage. The voltage clamp 85a generates the sustain pulse starting voltage or the reference voltage, and sets the sustain electrode group UG1 in the sustain period to the sustain pulse starting voltage or the reference voltage. The sustain pulse generating circuit 80a thus sustain pulses by repeatedly generating the pulse starting voltage and reference voltage, and applies the sustain pulses through the electrode path RG1 to the sustain electrode group UG1. In addition, sustain pulse generating circuit 80a receives specific voltage Ve1 from voltage selection circuit 200 on low voltage path R3L, and applies the specific voltage Ve1 through electrode path RG1 to the sustain electrode group UG1.

Voltage clamp 85b operates identically to voltage clamp 85a.

FIG. 13 is a waveform diagram showing the operation of the sustain electrode drive circuit 244 in the plasma display panel drive circuit 46. The top part of FIG. 13 shows the drive voltage waveform applied to sustain electrode group UG1 and sustain electrode group UG2. The bottom part of FIG. 13 shows the on/off states of switch Q85a, Q86a, Q85b, and Q86b, specific voltage application circuit 90a and 90b, and switch Q201 and Q202 based on timing signal S45.

To apply specific voltage 0 (V) to sustain electrode groups UG1, UG2 in initialization period Tin, switch Q201 turns ON; switch Q86a turns ON; sustain electrode group UG1 goes to ground; switch Q86b turns ON; and sustain electrode group UG2 goes to ground.

Next, to apply specific voltage Ve1 to sustain electrode groups UG1, UG2, switch Q201 turns OFF and switch Q202 turns ON. As a result, specific voltage Ve1 is applied to sustain electrode group UG1 through switches Q202, Q86a, and specific voltage Ve1 is applied through switches Q202, Q86b to sustain electrode group UG2.

In the following address period Tw1 of subfield SF1 in sustain electrode group UG1, switch Q86a turns OFF, specific voltage application circuit 90a turns ON, and specific voltage Ve2 is applied to sustain electrode group UG1. At the same time, switch Q86b turns OFF, specific voltage application circuit 90b turns ON, and specific voltage Ve2 is also applied to sustain electrode group UG2.

In sustain period Ts1 of subfield SF1 in sustain electrode group UG1, switch Q201 is ON and specific voltage 0 (V) is supplied to sustain pulse generating circuits 80a, 80b. Specific voltage application circuit 90a then turns OFF, and the sustain pulses generated by the sustain pulse generating circuit 80a are applied to the sustain electrode group UG1.

Because the sustain electrode group UG2 is in address period Tw1 of subfield SF1 at this time, specific voltage Ve2 is continuously applied to sustain electrode group UG2.

In the following erase period Te of subfield SF1 in the sustain electrode group UG1, switches Q81a, Q82a, Q85a, Q86a turn OFF, specific voltage application circuit 90a turns ON, and specific voltage Ve2 is applied to sustain electrode group UG1.

In the following address period Tw1 of subfield SF2 in sustain electrode group UG1, specific voltage Ve2 is continuously applied to sustain electrode group UG1.

In the address period Tw1 of subfield SF2 in the sustain electrode group UG1, sustain electrode group UG2 is in the sustain period Ts1 of subfield SF1. As a result, specific voltage application circuit 90b is OFF and the sustain pulses generated by the sustain pulse generating circuit 80b are applied to the sustain electrode group UG2.

Thereafter, the switches of the corresponding sustain pulse generating circuits are turned off and the corresponding specific voltage application circuit is turned on to apply specific voltage Ve2 to the sustain electrodes of the sustain electrode group in the address period Tw1. The corresponding specific voltage application circuit is then turned off and the corresponding sustain pulse generating circuit switches are controlled to apply sustain pulses to the sustain electrodes of the sustain electrode group in the sustain period.

By repeating the foregoing operation, the drive voltage waveform shown in FIG. 13 is applied to the sustain electrodes of the sustain electrode groups UG1, UG2.

As described above, the sustain electrode drive circuit 244 according to the third embodiment of the invention has a voltage selection circuit 200 that selects either specific voltage 0 (V) or specific voltage Ve1 as the specific voltage, and supplies the selected specific voltage to two sustain pulse generating circuits 80a, 80b. This circuit configuration can eliminate two switches similarly to the sustain electrode drive circuit 44 according to the first embodiment of the invention.

### Embodiment 4

The fourth embodiment of the invention is described below with reference primarily to the differences from the first to third embodiments. Other aspects of the configuration, operation, and effect of the fourth embodiment are the same as in the first to third embodiments, and further description thereof is omitted below.

FIG. 14 is a circuit diagram of the plasma display panel drive circuit 46 a. This plasma display panel drive circuit 46 a includes a scan electrode drive circuit 43c, scan electrode drive circuit 43d, sustain electrode drive circuit 344, back path RB1, and back path RB2 in addition to the circuit configuration of the plasma display panel drive circuit 46 shown in FIG. 5. More specifically, plasma display panel drive circuit 46 a has a power supply circuit that supplies the necessary power to the image signal processing circuit 41, data electrode drive circuit 42, timing signal generating circuit 45, and other circuit blocks. These other circuits are omitted from FIG. 14 for brevity, however.

Scan electrode drive circuit 43c also differs from scan electrode drive circuit 43a, scan electrode drive circuit 43d differs from scan electrode drive circuit 43b, and sustain electrode drive circuit 344 differs from sustain electrode drive circuit 44 (see FIG. 5, FIG. 6, and FIG. 7).

Scan electrode drive circuit 43c includes sustain pulse generating circuit 150a, initialization signal generating circuit 60a, and scan pulse generating circuit 70a. Sustain pulse generating circuit 150a includes voltage clamp 55a and energy recovery unit 151a. Initialization signal generating circuit 60a, scan pulse generating circuit 70a, and voltage clamp circuit 55a are configured as shown in FIG. 6. That is, the difference between scan electrode drive circuit 43c and scan electrode drive circuit 43a is the difference between energy recovery unit 151a and energy recovery unit 51. The difference between energy recovery unit 151a and energy recovery unit 51 is the elimination of energy recovery capacitor C51, and the connection of back path RB to the node PC1 to which the eliminated capacitor C51 was connected.

Similarly to scan electrode drive circuit 43c, scan electrode drive circuit 43d includes sustain pulse generating circuit 150b, initialization signal generating circuit 60b, and scan pulse generating circuit 70b. Sustain pulse generating circuit 150b includes voltage clamp 55b and energy recovery unit 151b. Sustain pulse generating circuit 150b, initialization signal generating circuit 60b, and scan pulse generating circuit 70b are configured identically to sustain pulse generating circuit 150a, initialization signal generating circuit 60a, and scan pulse generating circuit 70a, respectively. Energy recovery unit 151b is configured identically to energy recovery unit 151a, does not include a energy recovery capacitor, and has back path R2B connected to a node PC2 corresponding to node PC1.

Sustain electrode drive circuit 344 includes sustain pulse generating circuits 280a and 280b, specific voltage application circuits 90a and 90b, 10 voltage selection circuit 100, electrode path RG1, and electrode path RG2. Sustain electrode drive circuit 344 differs from sustain electrode drive circuit 44 in that the configuration of sustain pulse generating circuits 280a and 280b differs from the configuration of sustain pulse generating circuits 80a and 80b (see FIG. 7 and FIG. 12). Sustain pulse generating circuit 280a differs from sustain pulse generating circuit 80a in that energy recovery unit 81a is omitted, and back path RB1 is connected to the node PU1 to which the eliminated energy recovery unit 81a was connected. Likewise, sustain pulse generating circuit 280b differs from sustain pulse generating circuit 80b in that energy recovery unit 81b is omitted, and back path RB2 is connected to the node PU2 to which the eliminated energy recovery unit 81b was connected.

The plasma display panel drive circuit 46 a thus differs from plasma display panel drive circuit 46 in three ways. First, scan electrode drive circuit 43c does not have the power recover capacitor C51a of the scan electrode drive circuit scan electrode drive circuit 43a, and like scan electrode drive circuit 43c, scan electrode drive circuit 43d does not have the energy recovery capacitor of scan electrode drive circuit 43b. Second, sustain electrode drive circuit 344 does not have the energy recovery units 81a, 81b of sustain electrode drive circuit 44. Third, nodes PC1, PU1 are both connected to back path RB1, and nodes PC2, PU2 are both connected to back path RB2. The configuration, operation, and effect of these differences are described below.

In scan electrode drive circuit 43c, energy recovery unit 151a includes switches Q51a and Q52a, reverse current blocking diodes D51a and D52a, and resonance inductor L51a. The voltage clamp unit 55a includes switches Q55a and Q56a. One side of switch Q51a and one side of switch Q52a are both connected through node PC1 to back path RB1. The other side of switch Q51a is connected to the anode of diode D51a, and the other side of switch Q52a is connected to the cathode of diode D52a. The cathode of diode D51a and the node of diode D52a are both connected to one side of inductor L51a. The other side of inductor L51a is connected to a node between switch Q55a and switch Q56a.

In scan electrode drive circuit 43d, the energy recovery unit 151b includes switches Q51b and Q52b, reverse current blocking diodes D51b and D52b, and resonance inductor L51b. The voltage clamp unit 55b includes switches Q55b and Q56b. One side of switch Q51b and one side of switch Q52b are connected through a common node PC2 to back path RB2. The other side of switch Q51b is connected to the anode of diode D51b, and the other side of switch Q52b is connected to the cathode of diode D52b. The cathode of diode D51b and the anode of diode D52b are both connected to one side of inductor L51b. The other side of inductor L51b is connected to a node between switch Q55b and switch Q56b in voltage clamp unit 55b.

The energy recovery unit 151a LC resonates as a result of controlling switches Q51a, Q52a based on signal S45. More specifically, the energy recovery unit 151a produces LC resonance between inductor L51a and the 1080 interelectrode capacitances between the scan electrode group SG1 and sustain electrode group UG1 of display electrode pair group DG1, and causes the sustain pulses to rise and fall. At the rise of the sustain pulses in scan electrode group SG1, the energy recovery unit 151a supplies the charge (or power) in the sustain electrode group UG1 through a specific scan electrode supply path to scan electrode group SG1. The specific scan electrode supply path is a path through electrode path RG1, node PU1, back path RB1, node PC1, switch Q51a, diode D51a, inductor L51a, initialization signal generating circuit 60a, and scan pulse generating circuit 70a.

At the fall of the sustain pulses in scan electrode group SG1, the energy recovery unit 151a recovers the charge (or power) in the scan electrode group SG1 through a specific scan electrode recovery path to sustain electrode group UG1. This specific scan electrode recovery path is a path through scan pulse generating circuit 70a, initialization signal generating circuit 60a, inductor L51a, diode D52a, switch Q52a, node PC1, back path RB1, node PU1, separation switch unit 101, and electrode path RG1.

As described above, the energy recovery unit 151a recovers a charge (or power) from sustain electrode group UG1, and supplies the recovered charge (or power) directly to the scan electrode group SG1. As a result, the energy recovery unit 151a raises the sustain pulses of the sustain electrode group UG1 and lowers the sustain pulses of the scan electrode group SG1 in parallel temporally. The energy recovery unit 151a also recovers a charge (or power) from scan electrode group SG1, and supplies the recovered charge (or power) directly to sustain electrode group UG1. As a result, the energy recovery unit 151a lowers the sustain pulses of the scan electrode group SG1 while raising the sustain pulses of the sustain electrode group UG1 in parallel temporally.

Energy recovery unit 151b operates in the same way as the energy recovery unit 151a. That is, energy recovery unit 151b recovers a charge (or power) from sustain electrode group UG2, and supplies the recovered charge (or power) directly to scan electrode group SG2. As a result, energy recovery unit 151b lowers the sustain pulses in the sustain electrode group UG2 and raises the sustain pulses in the scan electrode group SG2 in parallel temporally. In addition, energy recovery unit 151b recovers a charge (or power) from scan electrode group SG2, and supplies the recovered charge (or power) directly to sustain electrode group UG2. As a result, energy recovery unit 151b lowers the sustain pulses of scan electrode group SG2 and raises the sustain pulses of sustain electrode group UG2 in parallel temporally.

FIG. 15 is a waveform diagram describing the operation of the plasma display panel drive circuit 46a. The top half of FIG. 15 shows the drive voltage waveforms of the scan electrode group SG1 and sustain electrode group UG1 in the display electrode pair group DG1, and the drive voltage waveforms of the scan electrode group SG2 and sustain electrode group UG2 in display electrode pair group DG2. The bottom half of FIG. 15 shows the on/off states of switches Q51a, Q52a, Q55a, Q56a, Q51b, Q52b, Q55b, Q56b, Q85a, Q86a, Q85b, and Q86b based on timing signal S45.

Just before the end of address period Tw1 in scan electrode group SG1, voltage 0 (V) is applied to scan electrode group SG1 and specific voltage Ve2 is applied to sustain electrode group UG1. In sustain period Ts1 after the address period Tw1 in scan electrode group SG1, switches Q52a, Q55a, Q56a first turn OFF and switch Q51a turns ON. At this time LC resonance is produced between inductor L51a and the 1080 interelectrode capacitances between the scan electrode group SG1 and sustain electrode group UG1 of display electrode pair group DG1. As a result, the voltage of scan electrode group SG1 rises from voltage 0 (V) to near voltage Vs, and the voltage of sustain electrode group UG1 simultaneously drops from voltage Ve2 to near voltage 0 (V).

Next, when switch Q55a and switch Q86 turn on, the voltage of scan electrode group SG1 is clamped to voltage Vs, and the voltage of sustain electrode group UG1 is clamped to voltage 0 (V). While the scan electrode group SG1 and sustain electrode group UG1 are clamped, discharge cell Cij emits. Next, switches Q51a, Q55a, Q86a turn off, and switch Q52a turns on. At this time LC resonance is again produced between the 1080 interelectrode capacitances and inductor L51a. As a result, the voltage of scan electrode group SG1 drops from voltage Vs to near voltage 0 (V), and the voltage of sustain electrode group UG1 simultaneously rises from voltage 0 (V) to near voltage Vs.

Next, when switch Q56a and switch Q85 turn on, the voltage of scan electrode group SG1 is clamped to voltage 0 (V), and the voltage of sustain electrode group UG1 is clamped to voltage Vs. Discharge cell Cij emits while scan electrode group SG1 and sustain electrode group UG1 are clamped.

Next, switch Q52a, Q56a, Q85a turn off, and switch Q51a turns on. At this time LC resonance is again produced between the 1080 interelectrode capacitances and inductor L51a. As a result, the voltage of scan electrode group SG1 rises from voltage 0 (V) to near voltage Vs, and the voltage of sustain electrode group UG1 simultaneously drops from voltage Vs to near voltage 0 (V).

By thereafter repeating this operation in sustain period Ts1, sustain pulse generating circuits 150a and 280a apply sustain pulses to display electrode pair group DG1, and cause discharge cells Cij (i=1−1080) to continue discharging.

During the sustain period Ts1 of scan electrode group SG1, scan electrode group SG2 is in the address period Tw1 and then goes to the sustain period Ts1 at the end of the address period Tw1. In the sustain period Ts1 of scan electrode group SG2, switches Q51b, Q52b, Q55b, Q56b, Q85b, Q86b are controlled based on timing signal S45. The operation of these switches is the same as the operation of switch Q51a, Q52a, Q55a, Q56a, Q85a, Q86a based on timing signal S45 in the sustain period Ts1 of scan electrode group SG1. As a result, sustain pulse generating circuit 150b and 280a apply sustain pulses to display electrode pair group DG2, and cause discharge cells Cij (i=1081−2160) to continue discharging.

Note that in the configuration shown in FIG. 14 the energy recovery unit is included in the scan electrode drive circuits 43c, 43d and is not included in the sustain electrode drive circuit 344, but conversely could be included in the sustain electrode drive circuit 344 and not the scan electrode drive circuits 43c, 43d. In this configuration energy recovery units 151a, 151b are omitted, back path RB1 is connected to a node between switch Q55a and switch Q56a, and back path RB2 is connected to a node between switch Q55b and switch Q56b. In addition, the sustain pulse generating circuit 280a is replaced by a circuit that omits the capacitance C81 from sustain pulse generating circuit 80a, and connects the back path RB1 to the node to which the eliminated capacitor C81a was connected. Sustain pulse generating circuit 280b is likewise replaced by a circuit that omits the capacitance C81b from sustain pulse generating circuit 80b, and connects the back path RB2 to the node to which the eliminated capacitor C81b was connected.

Note that the voltage selection circuit 100 in the sustain electrode drive circuit 344 may be replaced by the voltage selection circuit 200 shown in FIG. 12.

Note that in the foregoing embodiments the number of display electrode pair groups N is N=2 such as with display electrode groups DG1, DG2, but as described in the second embodiment (FIG. 9, FIG. 10, and FIG. 11), configurations in which N=4 or other desirable number are also conceivable. In such configurations, the energy recovery unit is omitted from the scan electrode drive circuit or sustain electrode drive circuit that drive the same display electrode pair group, and the energy recovery capacitor is omitted from the other energy recovery unit. In addition, the node to which the omitted energy recovery unit was connected, and the node to which the omitted energy recovery capacitor were connected, are connected by a back path.

In the plasma display panel drive circuit 46 a according to the fourth embodiment of the invention, a common energy recovery unit can be shared by scan electrode drive circuits 43c, 43d and the sustain electrode drive circuit 344. As a result, the part count associated with the energy recovery unit can be reduced and the cost can be reduced.

### CONCLUSION

As shown in FIG. 3, in the first to fourth embodiments described above, the subfield configuration is described as shifting the phase of all subfields in display electrode pair group DG1 and display electrode pair group DG2, but the invention is not limited to the subfield configurations described above. For example, the invention can also be applied to a subfield configuration containing some subfields that are controlled using a separated address and sustain method that aligns the sustain period phase of all discharge cells.

In the first to fourth embodiments as shown in FIG. 4, FIG. 8, and FIG. 13, specific voltage 0 (V) is applied to the sustain electrodes in the first part of the initialization period, and in the second half of the initialization period a specific voltage Ve1 that is lower than specific voltage Ve2 is applied. However, the drive voltage waveforms applied to the electrodes of the panel are described above by way of example only, and the invention is not so limited. For example, specific voltage Ve1 may be higher than specific voltage Ve2, and in the initialization period specific voltage Ve2 and specific voltage Vs may be applied to the sustain electrodes in addition to specific voltage 0 (V) and specific voltage Ve1.

Note that specific numeric values used in the foregoing embodiments are merely examples, and can obviously be appropriately set according to the panel characteristics and the plasma display device specifications, for example.

The invention can also provide a simple drive circuit that can secure a sufficient number of subfields even in a high resolution panel, and is therefore useful as a plasma display device.

As described above, a plasma display panel drive circuit according to the invention has one voltage selection circuit (100, 200) that generates one selected voltage V3, and plural sustain pulse generating circuits (80a, 80b;180a, 180b, 180c, 180d;280a, 280b) apply sustain pulses based on this one selected voltage V3 or specific voltage Ve1 in different sustain periods to plural sustain electrode groups (UG1, UG2;UG11, UG12, UG21, UG22). Because a sufficient number of subfields and sustain pulses can thus be secured in a high definition panel, a plasma display panel with high resolution and high luminance can be achieved. In addition, the parts count can be reduced and the circuit design can be simplified.

It will be obvious to one with ordinary skill in the related art that the numbers cited above are used simply to specifically describe preferred embodiments of the invention, and the invention is not limited thereto. In addition, components that are rendered by hardware can also be rendered by software, and components that are rendered in software can also be rendered by hardware. In addition, different combinations of effects can also be achieved by rearranging some of the components described above in combinations different from those described in the foregoing embodiments.

Use in Industry

The present invention can be used in plasma display panel drive circuits and plasma display devices.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1-4. (canceled)

5. A plasma display panel drive circuit that groups a plurality of sustain electrodes of the plasma display panel into at least a first sustain electrode group and second sustain electrode group, and applies sustain pulses in a sustain period, the drive circuit comprising:
a first sustain pulse generating circuit that generates sustain pulses and applies sustain pulses at a first specific timing to a first electrode path to the first sustain electrode group;
a second sustain pulse generating circuit that generates sustain pulses and applies sustain pulses at a second specific timing to a second electrode path to the second sustain electrode group;
a first specific voltage application circuit that applies a first specific voltage to the first electrode path at a third specific timing;
a second specific voltage application circuit that applies the first specific voltage to the second electrode path at a fourth specific timing; and
a voltage selection circuit that selects one voltage from a plurality of voltages including at least the second specific voltage and the third specific voltage, and generates a selected voltage;
wherein the first sustain pulse generating circuit generates sustain pulses based on the second specific voltage when the selected voltage is the second specific voltage, and when the selected voltage is the third specific voltage, applies the third specific voltage to the first electrode path at a fifth specific timing, and
wherein the second sustain pulse generating circuit generates sustain pulses based on the second specific voltage when the selected voltage is the second specific voltage, and when the selected voltage is the third specific voltage, applies the third specific voltage to the second electrode path at a sixth specific timing.

6. The plasma display panel drive circuit described in claim 5, wherein:
the first sustain pulse generating circuit and the second sustain pulse generating circuit each have a high voltage path and a low voltage path, and
generate the sustain pulses by repeating a specific high voltage from the high voltage path and a specific low voltage from the low voltage path, and
the high voltage path receives the selected voltage.

7. The plasma display panel drive circuit described in claim 5, wherein:
the first sustain pulse generating circuit and the second sustain pulse generating circuit each have a high voltage path and a low voltage path, and
generate the sustain pulses by repeating a specific high voltage from the high voltage path and a specific low voltage from the low voltage path, and
the low voltage path receives the selected voltage.

8. A plasma display device comprising:
the plasma display panel drive circuit described in claim 5; and
the plasma display panel.
